(19) United States
(12) Patent Application Publication
(10) Pub. No.: US 2026/0343552 A1
(43) Pub. Date: Oct. 29, 2026

(54) TRANSMISSION OF MEDIUM ACCESS CONTROL INFORMATION ACCORDING TO UPLINK GRANT SIZES

(71) Applicant: QUALCOMM Incorporated, San Diego, CA (US)

(72) Inventors: Sherif ELAZZOUNI, San Diego, CA (US); Ozcan OZTURK, San Diego, CA (US)

(21) Appl. No.: 19/299,771

(22) Filed: Aug. 14, 2025

Related U.S. Application Data
(60) Provisional application No. 63/794,484, filed on Apr. 25, 2025.

(51) Int. Cl. H04W 72/21; H04W 28/02; H04W 72/115; H04W 72/1263

(52) U.S. Cl. CPC H04W 72/21; H04W 28/0278; H04W 72/115; H04W 72/1263

(57) ABSTRACT

Various aspects of the present disclosure generally relate to wireless communication. In some aspects, a user equipment (UE) may receive, from a network node, configuration information that configures a logical channel group (LCG) for reporting one or more pending medium access control (MAC) control elements (MAC-CEs). The UE may receive, from the network node, an uplink grant that indicates a first amount of resources configured for an uplink transmission. The UE may transmit, to the network node, the uplink transmission, where the uplink transmission includes information corresponding to the LCG and the information is based on a second amount of resources of the uplink transmission allocated for the LCG. Numerous other aspects are described.

### CROSS-REFERENCE TO RELATED APPLICATION

This Patent Application claims priority to U.S. Provisional Patent Application No. 63/794,484, filed on Apr. 25, 2025, entitled “TRANSMISSION OF MEDIUM ACCESS CONTROL INFORMATION ACCORDING TO UPLINK GRANT SIZES,” and assigned to the assignee hereof. The disclosure of the prior Application is considered part of and is incorporated by reference into this Patent Application.

### FIELD OF THE DISCLOSURE

Aspects of the present disclosure generally relate to wireless communication and specifically relate to techniques, apparatuses, and methods associated with transmission of medium access control information according to uplink grant sizes.

### DESCRIPTION OF THE RELATED TECHNOLOGY

Wireless communication systems are widely deployed to provide various services, which may involve carrying or supporting voice, text, other messaging, video, data, or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, or device transmit power, among other examples). Such multiple-access RATs are supported by technological advancements that have been adopted in various telecommunication standards, which define common protocols that enable different wireless communication devices to communicate on a local, municipal, national, regional, or global level. An example telecommunication standard is New Radio (NR). NR, which also may be referred to as 5G, is part of a continuous mobile broadband evolution promulgated by the Third Generation Partnership Project (3GPP). As the demand for connectivity continues to increase, further improvements in NR may be implemented, and other RATs, such as 6G and beyond, may be introduced to enable new applications and facilitate new use cases.

### SUMMARY

The systems, methods, and devices of this disclosure each have several innovative aspects, no single one of which is solely responsible for the desirable attributes disclosed herein.

Some aspects described herein relate to a user equipment (UE) for wireless communication. The UE may include one or more memories and one or more processors coupled to the one or more memories. The one or more processors may be configured to receive, from a network node, configuration information that configures a logical channel group (LCG) for reporting one or more pending medium access control (MAC) control elements (MAC-CEs). The one or more processors may be configured to receive, from the network node, an uplink grant that indicates a first amount of resources configured for an uplink transmission. The one or more processors may be configured to transmit, to the network node, the uplink transmission, wherein the uplink transmission includes information corresponding to the LCG, and wherein the information is based at least in part on a second amount of resources of the uplink transmission allocated for the LCG.

Some aspects described herein relate to a UE for wireless communication. The UE may include one or more memories and one or more processors coupled to the one or more memories. The one or more processors may be configured to receive, from a network node, a first uplink grant that indicates a first amount of resources configured for a first uplink transmission, wherein the first amount of resources does not satisfy a data size for a MAC-CE. The one or more processors may be configured to transmit, to the network node, the first uplink transmission that includes a first portion of the MAC-CE, wherein the first amount of resources satisfies a data size of an initial portion of the MAC-CE.

Some aspects described herein relate to a network node for wireless communication. The network node may include one or more memories and one or more processors coupled to the one or more memories. The one or more processors may be configured to transmit, to a UE, configuration information that configures an LCG for reporting one or more pending MAC-CEs. The one or more processors may be configured to transmit, to the UE, an uplink grant that indicates a first amount of resources configured for an uplink transmission. The one or more processors may be configured to receive, from the UE, the uplink transmission, wherein the uplink transmission includes information corresponding to the LCG, and wherein the information is based at least in part on a second amount of resources of the uplink transmission allocated for the LCG.

Some aspects described herein relate to a network node for wireless communication. The network node may include one or more memories and one or more processors coupled to the one or more memories. The one or more processors may be configured to transmit, to a UE, a first uplink grant that indicates a first amount of resources configured for a first uplink transmission, wherein the first amount of resources does not satisfy a data size for a MAC-CE. The one or more processors may be configured to receive, from the UE, the first uplink transmission that includes a first portion of the MAC-CE, wherein the first amount of resources satisfies a data size of an initial portion of the MAC-CE.

Some aspects described herein relate to a method of wireless communication performed by a UE. The method may include receiving, from a network node, configuration information that configures an LCG for reporting one or more pending MAC-CEs. The method may include receiving, from the network node, an uplink grant that indicates a first amount of resources configured for an uplink transmission. The method may include transmitting, to the network node, the uplink transmission, wherein the uplink transmission includes information corresponding to the LCG, and wherein the information is based at least in part on a second amount of resources of the uplink transmission allocated for the LCG.

Some aspects described herein relate to a method of wireless communication performed by a UE. The method may include receiving, from a network node, a first uplink grant that indicates a first amount of resources configured for a first uplink transmission, wherein the first amount of resources does not satisfy a data size for a MAC-CE. The method may include transmitting, to the network node, the first uplink transmission that includes a first portion of the MAC-CE, wherein the first amount of resources satisfies a data size of an initial portion of the MAC-CE.

Some aspects described herein relate to a method of wireless communication performed by a network node. The method may include transmitting, to a UE, configuration information that configures an LCG for reporting one or more pending MAC-CEs. The method may include transmitting, to the UE, an uplink grant that indicates a first amount of resources configured for an uplink transmission. The method may include receiving, from the UE, the uplink transmission, wherein the uplink transmission includes information corresponding to the LCG, and wherein the information is based at least in part on a second amount of resources of the uplink transmission allocated for the LCG.

Some aspects described herein relate to a method of wireless communication performed by a network node. The method may include transmitting, to a UE, a first uplink grant that indicates a first amount of resources configured for a first uplink transmission, wherein the first amount of resources does not satisfy a data size for a MAC-CE. The method may include receiving, from the UE, the first uplink transmission that includes a first portion of the MAC-CE, wherein the first amount of resources satisfies a data size of an initial portion of the MAC-CE.

Some aspects described herein relate to a non-transitory computer-readable medium that stores a set of instructions for wireless communication by a UE. The set of instructions, when executed by one or more processors of the UE, may cause the UE to receive, from a network node, configuration information that configures an LCG for reporting one or more pending MAC-CEs. The set of instructions, when executed by one or more processors of the UE, may cause the UE to receive, from the network node, an uplink grant that indicates a first amount of resources configured for an uplink transmission. The set of instructions, when executed by one or more processors of the UE, may cause the UE to transmit, to the network node, the uplink transmission, wherein the uplink transmission includes information corresponding to the LCG, and wherein the information is based at least in part on a second amount of resources of the uplink transmission allocated for the LCG.

Some aspects described herein relate to a non-transitory computer-readable medium that stores a set of instructions for wireless communication by a UE. The set of instructions, when executed by one or more processors of the UE, may cause the UE to receive, from a network node, a first uplink grant that indicates a first amount of resources configured for a first uplink transmission, wherein the first amount of resources does not satisfy a data size for a MAC-CE. The set of instructions, when executed by one or more processors of the UE, may cause the UE to transmit, to the network node, the first uplink transmission that includes a first portion of the MAC-CE, wherein the first amount of resources satisfies a data size of an initial portion of the MAC-CE.

Some aspects described herein relate to a non-transitory computer-readable medium that stores a set of instructions for wireless communication by a network node. The set of instructions, when executed by one or more processors of the network node, may cause the network node to transmit, to a UE, configuration information that configures an LCG for reporting one or more pending MAC-CEs. The set of instructions, when executed by one or more processors of the network node, may cause the network node to transmit, to the UE, an uplink grant that indicates a first amount of resources configured for an uplink transmission. The set of instructions, when executed by one or more processors of the network node, may cause the network node to receive, from the UE, the uplink transmission, wherein the uplink transmission includes information corresponding to the LCG, and wherein the information is based at least in part on a second amount of resources of the uplink transmission allocated for the LCG.

Some aspects described herein relate to a non-transitory computer-readable medium that stores a set of instructions for wireless communication by a network node. The set of instructions, when executed by one or more processors of the network node, may cause the network node to transmit, to a UE, a first uplink grant that indicates a first amount of resources configured for a first uplink transmission, wherein the first amount of resources does not satisfy a data size for a MAC-CE. The set of instructions, when executed by one or more processors of the network node, may cause the network node to receive, from the UE, the first uplink transmission that includes a first portion of the MAC-CE, wherein the first amount of resources satisfies a data size of an initial portion of the MAC-CE.

Some aspects described herein relate to an apparatus for wireless communication. The apparatus may include means for receiving, from a network node, configuration information that configures an LCG for reporting one or more pending MAC-CEs. The apparatus may include means for receiving, from the network node, an uplink grant that indicates a first amount of resources configured for an uplink transmission. The apparatus may include means for transmitting, to the network node, the uplink transmission, wherein the uplink transmission includes information corresponding to the LCG, and wherein the information is based at least in part on a second amount of resources of the uplink transmission allocated for the LCG.

Some aspects described herein relate to an apparatus for wireless communication. The apparatus may include means for receiving, from a network node, a first uplink grant that indicates a first amount of resources configured for a first uplink transmission, wherein the first amount of resources does not satisfy a data size for a MAC-CE. The apparatus may include means for transmitting, to the network node, the first uplink transmission that includes a first portion of the MAC-CE, wherein the first amount of resources satisfies a data size of an initial portion of the MAC-CE.

Some aspects described herein relate to an apparatus for wireless communication. The apparatus may include means for transmitting, to a UE, configuration information that configures an LCG for reporting one or more pending MAC-CEs. The apparatus may include means for transmitting, to the UE, an uplink grant that indicates a first amount of resources configured for an uplink transmission. The apparatus may include means for receiving, from the UE, the uplink transmission, wherein the uplink transmission includes information corresponding to the LCG, and wherein the information is based at least in part on a second amount of resources of the uplink transmission allocated for the LCG.

Some aspects described herein relate to an apparatus for wireless communication. The apparatus may include means for transmitting, to a UE, a first uplink grant that indicates a first amount of resources configured for a first uplink transmission, wherein the first amount of resources does not satisfy a data size for a MAC-CE. The apparatus may include means for receiving, from the UE, the first uplink transmission that includes a first portion of the MAC-CE, wherein the first amount of resources satisfies a data size of an initial portion of the MAC-CE.

Aspects of the present disclosure may generally be implemented by or as a method, apparatus, system, computer program product, non-transitory computer-readable medium, user equipment, network node, wireless communication device, or processing system as substantially described in the Detailed Description with reference to, and as illustrated by, the accompanying drawings. Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only some aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless communication network.

FIG. 2 is a diagram of an example in accordance with configuring logical channel group (LCGs) for buffering pending medium access control (MAC) control elements (MAC-CEs).

FIG. 3 is a diagram of an example in accordance with transmitting multiple segments of a MAC-CE across multiple uplink transmissions.

FIG. 4 is a diagram of an example in accordance with indicating a MAC-CE segment of a MAC-CE.

FIG. 5 is a diagram of an example in accordance with indicating a MAC-CE segment of a MAC-CE.

FIG. 6 is a diagram illustrating an example associated with signaling that enables one or more LCGs for the communication of MAC-CEs.

FIG. 7 is a diagram illustrating an example associated with signaling that enables segmenting a MAC-CE across multiple uplink transmissions.

FIG. 8 is a diagram illustrating an example process performed, for example, at a user equipment (UE) or an apparatus of a UE.

FIG. 9 is a diagram illustrating an example process performed, for example, at a UE or an apparatus of a UE.

FIG. 10 is a diagram illustrating an example process performed, for example, at a network node or an apparatus of a network node.

FIG. 11 is a diagram illustrating an example process performed, for example, at a network node or an apparatus of a network node.

FIG. 12 is a diagram of an example apparatus for wireless communication.

FIG. 13 is a diagram of an example apparatus for wireless communication.

### DETAILED DESCRIPTION

In wireless communication systems, medium access control (MAC) control elements (MAC-CEs) play a role in the uplink transmission process by providing information from a user equipment (UE) to the network node. These control elements can include power headroom, buffer status reports (BSRs), and timing advance reports, among others. In some examples, MAC-CEs are transmitted during transmission time intervals (TTIs) granted by the network node and are transmitted when sufficient uplink resources are available to accommodate them. If a MAC-CE cannot fit within the granted uplink resources, the UE may defer the transmission of the MAC-CE until sufficient resources are allocated, trigger a scheduling request (SR) to solicit additional uplink resources from the network, or transmit a truncated version of the MAC-CE.

However, as wireless communications evolve, the complexity and size of MAC-CEs may increase. For example, the sizes of MAC-CEs have become larger due to the inclusion of detailed cell, beam, transmission configuration indication (TCI), and hybrid automatic repeat request (HARQ) process granularity level information. Consequently, the increased sizes of MAC-CEs and the tendency toward more in-band signaling complicate network ability to determine the appropriate grant size for these control elements. In congested networks, this challenge is exacerbated, increasing a difficulty in the allocation of sufficient resources for MAC-CE transmission without causing delays.

Delays in transmitting MAC-CEs can have implications, such as for elements that are latency-sensitive and influence network operations such as mobility decisions. For instance, an event-triggered Layer 1 measurement report, which is large due to the inclusion of beam-level measurements, may be time-critical as the report affects the network ability to perform a cell switch. Delays in transmitting this report could lead to radio link failure (RLF) at the UE if not addressed promptly. Therefore, the network node and UE may experience difficulty in efficiently handling the transmission of increasingly large and time-sensitive MAC-CEs when the available uplink resources are insufficient or not optimally allocated, without causing undue delays that could impact the quality of service and network operations.

Various aspects relate generally to enhancing the efficiency of transmitting MAC-CEs in wireless communication systems. Some aspects more specifically relate to a UE receiving configuration information from a network node that configures a logical channel group (LCG) for reporting one or more pending MAC-CEs. The UE may then receive an uplink grant indicating a first amount of resources configured for uplink transmission. Based on this grant, the UE transmits information to the network node corresponding to the LCG, where this information is based on a second amount of resources of the uplink transmission allocated for the LCG. In some aspects, the UE may perform a data volume calculation for MAC-CE data buffered at the LCG. This calculation may be based on the pending MAC-CEs or a subset thereof as indicated by configuration information. Multiple LCGs can be used for reporting different pending MAC-CEs, and each LCG can include different types of MAC-CEs, which are identified by their respective logical channel IDs (LCIDs). The transmitted information in the uplink transmission may include a full or truncated BSR indicating pending MAC-CE data buffered at the LCG, based on whether the amount of grant resources can accommodate the data size of the MAC-CEs. If the resources are insufficient for a truncated BSR, a scheduling request (SR) may be transmitted instead. In some other aspects, the UE may be configure to segment a MAC-CE into multiple MAC-CE segments for transmission over multiple uplink transmission.

Particular aspects of the subject matter described in this disclosure can be implemented to realize one or more potential technical advantages. By transmitting a BSR that corresponds to specific LCGs for MAC-CEs, the UE efficiently communicates MAC-CE data characteristics to the network node, enabling more precise resource allocation and optimizing the use of uplink grants. This reduces overhead and conserves network resources by minimizing unnecessary scheduling requests. Furthermore, the capability of the UE to report pending MAC-CE data using LCGs allows the network to allocate resources with consideration to the criticality and urgency of different MAC-CEs. This prioritization mechanism effectively manages network traffic and enhances the responsiveness for high-priority and delay-sensitive MAC-CEs, thus conserving processing and network resources associated with handling service degradation or network operation impacts. Moreover, the segmentation of MAC-CEs enables the UE to adapt to the varying sizes of uplink grants and make full use of the allocated resources. This segmentation facilitates the transmission of MAC-CEs over multiple grants when resources are limited, ensuring that critical control information is conveyed without delay. In this way, the solution may conserve one or more of processing resources, memory resources, or network resources, by reducing the need for retransmissions and efficiently utilizing network capacity. Overall, the described techniques provide a more technical and resource-efficient approach to handling MAC-CE transmissions, that can accommodate for increasing MAC-CE sizes and complexity in evolving wireless communication systems. These techniques enable improved network congestion management and resource allocation, thereby maintaining high-quality service in scenarios characterized by resource constraints.

5G New Radio (NR) may support enhanced mobile broadband (eMBB) access, Internet of Things (IoT) networks or reduced capability (RedCap) device deployments, ultra-reliable low-latency communication (URLLC) applications, or massive machine-type communication (mMTC), among other examples. To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial or aerial platforms, among other examples.

The methods, operations, apparatuses, and techniques described herein may enable one or more of the foregoing technologies or new technologies or support one or more of the foregoing use cases or new use cases.

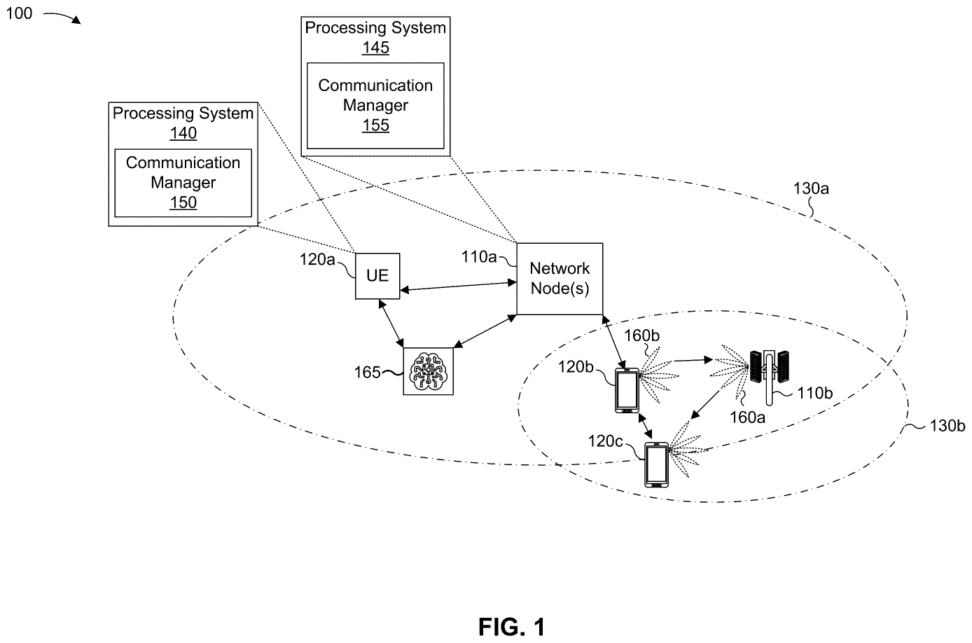

FIG. 1 is a diagram illustrating an example of a wireless communication network 100. The wireless communication network 100 may be or may include elements of a 5G network or a 6G network, among other examples. The wireless communication network 100 may include multiple network nodes 110. For example, in FIG. 1, the wireless communication network 100 includes multiple network nodes 110, including a network node 110a and a network node 110b (each of which also may be referred to herein simply as a “network node 110”). The network nodes 110 may support communications with multiple UEs 120. For example, in FIG. 1, the network nodes 110 support communication with a UE 120a, a UE 120b, and a UE 120c (each of which also may be referred to herein simply as a “UE 120”). In some examples, a UE 120 also may communicate with other UEs 120 and a network node 110 also may communicate with a core network and with other network nodes 110.

The network nodes 110 and the UEs 120 of the wireless communication network 100 communicate using the electromagnetic spectrum, which may be subdivided into various licensed or unlicensed operating bands, frequency ranges, component carriers, or channels that define associated frequencies available for communications. In some examples, each of the network nodes 110 and the UEs 120 may communicate using one or multiple component carriers in one or more operating bands or ranges. Typically, various operating bands are defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles.

A network node 110 or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system. As shown in FIG. 1, each UE 120 includes a processing system 140 and each network node 110 includes a processing system 145. A processing system (for example, the processing system 140 or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media, such as random-access memory, or read-only memory, or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors. One or more of the memories may individually or collectively store processor-executable code or instructions (such as software) (for example, which may be referred to as “one or more code-storing memories” or “code-storing memory circuitry”). For example, “code-storing memory” or “code-storing memory circuitry” refers to memory (or memory circuitry) that is configured to store processor-executable code or instructions. The processor-executable code or instructions, when executed by one or more of the processors, may configure one or more of the processors (or processing circuitry) to perform various functions or operations described herein. Additionally, or alternatively, in some examples, one or more of the processors may be configured to perform various functions or operations described herein without requiring configuration by software. Software shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 or the processing system 145 may include or implement one or more of the modems. The processing system 140 and the processing system 145 also may include or be coupled with multiple radios (collectively “the radio”), multiple RF chains, or multiple transceivers, each of which may in turn be coupled with one or more of multiple antennas. In some examples, one or more processors of the processing system 140 or the processing system 145 may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by the processing system 140 or by the processing system 145).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device, such as the network node 110 and the UE 120.

A network node 110 may be, may include, or also may be referred to as an NR network node, a 5G network node, a 6G network node, a Node B, a gNB, an access point (AP), a transmission reception point (TRP), a network entity, a network element, a network equipment, or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may include a single standalone base station or a single TRP that operates with a full radio protocol stack to enable or facilitate communication between a UE 120 and a core network of the wireless communication network 100.

Alternatively, a network node 110 may be a disaggregated network node 110 (sometimes referred to as a disaggregated base station), having a disaggregated architecture, meaning that the network node 110 may operate with a radio protocol stack that is physically distributed or logically distributed among two or more nodes in the same geographic location or in different geographic locations. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The disaggregated network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A CU can communicate with a core network either directly (for example, via a backhaul link) or indirectly (for example, via one or more disaggregated control units, such as a non-real-time (Non-RT) RAN intelligent controller (RIC) associated with a Service Management and Orchestration (SMO) framework or a near-real-time (Near-RT) RIC). A DU may host one or more of a radio link control (RLC) layer, a medium access control (MAC) layer, or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. A CU may communicate with one or more DUs via respective midhaul links, such as via F1 interfaces. Each of the DUs may communicate with one or more RUs via respective fronthaul links. Each of the RUs may communicate with one or more UEs 120 via respective RF access links. In some deployments, a UE 120 may be simultaneously served by multiple RUs.

In some examples, a single network node 110 may include a combination of one or more CUs, one or more DUs, or one or more RUs. In some examples, a CU, a DU, or an RU may be implemented as a virtual unit, such as a virtual central unit (VCU), a virtual distributed unit (VDU), or a virtual radio unit (VRU), among other examples, which may be implemented as a virtual network function, such as in a cloud deployment (for example, an open cloud (O-Cloud) platform). An SMO framework may support RAN deployment and provisioning of non-virtualized and virtualized network elements.

In some examples, the wireless communication network 100 may be a heterogeneous network that includes network nodes 110 of various types. Different types of network nodes 110 may generally operate on the same or different operating bands, transmit at different power levels, or serve different coverage areas, each of which may be referred to as or associated with a particular cell 130 (for example, a cell 130a and a cell 130b).

The UEs 120 may be physically dispersed throughout the coverage area of the wireless communication network 100, and each UE 120 may be stationary or mobile. A UE 120 may be, may include, or also may be referred to as an access terminal, a mobile station, a client device, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), an artificially intelligent robot or other device implementing artificial intelligence, a UE function of a network node, or any other suitable device or function that may communicate in the wireless communication network 100.

Some UEs 120 may be classified according to different categories in association with different complexities or different capabilities. UEs 120 in a first category may be associated with relatively low complexity or cost such as NB-IoT devices or eMTC UEs. UEs 120 in a second category may include higher complexity or cost devices, such as mission-critical IoT devices, baseline UEs, high-tier UEs, advanced UEs, full-capability UEs, or premium UEs that are capable of URLLC, eMBB, or precise positioning in the wireless communication network 100. A third category of UEs 120 may have mid-tier complexity or capabilities (for example, capabilities between that of the UEs 120 of the first category and the UEs 120 of the second category). A UE 120 of the third category may be referred to as a reduced capability UE (“RedCap UE”), a mid-tier UE, an NR-Light UE, or an NR-Lite UE, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) or reconfigured (for example, in real-time or near-real-time) according to changing network conditions in the wireless communication network 100 or specific requirements of one or more UEs 120. An active BWP defines the operating bandwidth of the UE 120 within the operating bandwidth of the serving cell.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120 or may transmit, to the UE 120, an indication of an MCS to be applied for an uplink signal.

A network node 110 or a UE 120 (such as by using the processing system 145 or the processing system 140, respectively, or one or more coupled modems) may perform signal processing on the information (such as filtering, amplification, modulation, digital-to-analog conversion, an IFFT operation, multiplexing, interleaving, mapping, or encoding, among other examples) to generate a processed signal in accordance with the selected MCS. In some examples, the network node 110 or the UE 120 (for example, using the processing system 145 or the processing system 140, respectively, or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 or one or more modems) may further perform spatial processing (for example, precoding) on the encoded information to generate one or more processed or precoded signals for downlink or uplink transmission, respectively. In some examples, the network node 110a or the UE 120a may perform codebook-based precoding or non-codebook-based precoding. Codebook-based precoding may involve selecting a precoder (for example, a precoding matrix) using a codebook. For example, the network node 110a may provide precoding information indicating which precoder, defined by the codebook, is to be used by the UE 120a. Non-codebook-based precoding may involve selecting or deriving a precoder based on, or otherwise associated with, one or more downlink or uplink signal measurements. The network node 110a or the UE 120a may transmit the processed downlink or uplink signals, respectively, via one or more antennas.

The network node 110a or the UE 120a may receive uplink signals or downlink signals, respectively, via one or more antennas. The network node 110a or the UE 120a (for example, using the processing system 145 or the processing system 140, respectively, or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, or decoding, among other examples), to map the received signal(s) to a sequence of binary bits (for example, received information) that estimates the information transmitted by the network node 110 or the UE 120 via the downlink or uplink signals. The network node 110a or the UE 120a (for example, using the processing system 145 or the processing system 140, respectively, or a coupled decoder or one or more modems) may decode the received information (such as by using an ECC, a decoding operation, or an FEC operation) to detect errors or correct bit errors in the received information to generate decoded information. The decoded information may estimate the information transmitted via the downlink or uplink signals.

In some examples, a UE 120 and a network node 110 may perform MIMO communication. MIMO communication generally refers to transmitting or receiving multiple signals (such as multiple layers or multiple data streams) simultaneously over the same time and frequency resources. A network node 110 or a UE 120 may communicate using single-user MIMO or multi-user MIMO (MU-MIMO), the latter of which being used by a network node 110 to simultaneously transmit signals to multiple UEs 120. MIMO techniques may involve spatial multiplexing (multi-layer transmission) or beamforming. To implement beamforming, the amplitudes or phases of signals transmitted via antenna elements may be modulated and shifted relative to each other (such as by manipulating a phase shift, a phase offset, or an amplitude) to generate one or more beams. For example, a network node 110 may generate one or more beams 160a, and a UE 120 may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with such a directional transmission or directional reception, a set of directional resources associated with a signal transmission or signal reception (for example, an angle of arrival, a horizontal direction, or a vertical direction), or a set of parameters or resources associated with one or more aspects of a directional signal, among other examples.

In some examples, a network node 110 or a UE 120 may implement massive MIMO, which may be associated with an increased (for example, “massive”) quantity of antennas at the network node 110 or at the UE 120, such as in a network implementing mmWave technology, which enables more precise beamforming or reduced interference. In some examples, the wireless communication network 100 may implement multi-TRP (mTRP) operation (including redundant transmission or reception on multiple TRPs) or non-coherent joint transmission (NC-JT).

The network node 110 and the UE 120 may establish a communication link or beam pair, and otherwise increase reliability, throughput, signal strength, or other signal properties for MIMO communications, by performing beam management operations, such as an initial beam acquisition operation, a beam refinement operation, or a beam recovery operation. For example, an initial beam acquisition operation may involve the network node 110 transmitting signals (for example, SSBs or other signals) via respective beams (for example, of the beams 160 of the network node 110) and the UE 120 receiving and measuring the signal(s) via respective beams of multiple beams (for example, from the beams 160 of the UE 120) to identify a best beam (or beam pair) for communication between the UE 120 and the network node 110. A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified or defined via one or more spatial parameters, such as a transmission configuration indicator (TCI) state or a quasi co-location (QCL) parameter, among other examples.

Some aspects and techniques as described herein may be implemented, at least in part, using an artificial intelligence (AI) program (for example, referred to herein as an “AI/ML model”), such as a program that includes a machine learning (ML) model or an artificial neural network (ANN) model. The AI/ML model may be deployed at one or more devices 165 (for example, one or more network nodes 110, one or more UEs 120, one or more servers, or one or more components of a cloud computing network, among other examples). For example, in a deployment in which AI/ML functionality is performed independently at a device 165, sometimes referred to as “overlay AI/ML,” the AI/ML model (or an instance or portion of the AI/ML model) may be deployed at a UE 120 (for example, by the processing system 140), a network node 110 (for example, by the processing system 145), one or more servers, or one or more components of a cloud computing network, among other examples. Additionally, or alternatively, in a deployment where AI/ML functionality is coordinated between different devices 165, sometimes referred to as “coordinated AI/ML,” or performed at all device and network layers, sometimes referred to as “native AI/ML,” the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, or efficient use of network bandwidth, or to reduce latency, among other examples). For example, the AI/ML model(s) may be trained to identify patterns or relationships in data corresponding to the wireless communication network 100, a device, or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases, such as a self-organizing network (SON), minimization of drive test (MDT), quality of experience (QoE), positioning, sensing, predictive mobility, or traffic prediction, among other examples. In some examples, AI-as-a-Service use cases may include measurement collection reporting by a UE 120, device selection criteria (for example, according to a geographical area where measurements are to be collected or UE capabilities to be used to collected measurements), or reporting configurations (for example, reporting parameters such as location, time, or sensor information, among other examples). Additionally, or alternatively, the AI/ML model(s) may enable AI/ML procedures (for example, RAN-triggered service establishment, configuration, inferencing using UE-side or network-side models, performance monitoring or management, or capability signaling, among other examples). Additionally, or alternatively, the AI/ML model(s) may enable RAN-based AI/ML services via one or more application program interfaces (APIs) or management interfaces for use cases, such as beam management, radio resource monitoring (RRM) relaxation, mobility prediction, load prediction, network energy savings, or coverage and capacity improvements, among other examples.

In some examples, one or more MAC-CEs may be triggered and transmitted by the UE 120 only if an available uplink grant size is sufficient to accommodate the MAC-CEs. In other words, the transmission of these control elements may be contingent upon having enough allocated resources to include them in the data packet. In some examples, the UE 120 or network node 110 may operate according to a wireless communications standard (such as 3GPP technical specification (TS) 38.321). In such operations, the transmission of a MAC-CE for power headroom reports (PHRs) is conditional upon the availability of sufficient uplink resources (e.g., uplink resources above a threshold). For instance, (referencing TS 38.321, clause 5.4.3.1) the MAC-CE for PHR, along with an associated subheader, may only be transmitted if the allocated uplink resources can accommodate a data size of the MAC-CE as a result of the logical channel prioritization (LCP) process.

If there are not enough uplink shared channel (UL-SCH) resources available to transmit a MAC-CE, the UE 120 can trigger an SR. Specifically, if UL-SCH resources are available for an upcoming uplink transmission and these resources can accommodate the timing advance report MAC-CE and the MAC-CE subheader as a result of logical channel prioritization, the UE 120 operates according to a multiplexing and assembly procedure to generate the Timing Advance Report MAC-CE (e.g., as defined in TS 38.321 clause 6.1.3.56). However, if the UL-SCH resources are insufficient, and if the information element (IE) timingAdvanceSR is configured with the value enabled, the UE 120 triggers an SR triggered to request additional resources. This ensures that the one or more MAC-CEs can be transmitted when sufficient resources become available.

When a data size of a MAC-CE does not fit into the available grant, the UE 120 may perform one or more operations. In some examples, the MAC-CE is not sent if the available grant is insufficient to accommodate it. In other words, the UE 120 may withhold the control element until a suitable grant is available in future transmissions. In some examples, the MAC-CE is not transmitted and SR is triggered. For instance, the MAC-CE is not transmitted due to the insufficient grant size, and an SR is triggered. The SR may be a request (e.g., 1 bit) for additional uplink resources, prompting the network to allocate a larger grant in subsequent transmissions to accommodate the MAC-CE. In some examples, the UE 120 may transmit a truncated version of the MAC-CE. For instance, a truncated version of the MAC-CE is transmitted if the full control element cannot fit into the available grant. In other words, a portion of the MAC-CE is sent, potentially omitting some information, but ensuring that at least part of the control element is communicated to the network.

As described herein, the transmission of a MAC-CE can be delayed if the UL-SCH grant resources are insufficient or unavailable. Some MAC-CEs trigger an SR to obtain the enough resources for transmission. If the grant received in response to the SR is still insufficient to accommodate the MAC-CE, then the UE 120 may trigger and transmit another SR, continuing this process until a sufficiently large grant is received. However, various MAC-CEs (e.g., Long-Term Measurement (LTM) Report MAC-CE) may experience problems with transmission delay. For instance, the event-triggered Layer 1 (L1) Measurement Report is particularly large (compared to other MAC-CEs) because of including beam-level measurements. This MAC-CE is also latency-sensitive, as delays in transmission can impact a network node 110 ability to perform a cell switch and may lead to Radio Link Failure (RLF) at the UE 120. Accordingly, the size and latency sensitivity of the MAC-CE mean that any delay or truncation could significantly reduce network node 110 performance and reliability.

Additionally, various RATs (such as 6G) are associated the transmission of more information within MAC-CEs. For instance, some RATs may exhibit the inclusion of information previously included in UCI reporting (e.g., CSI reporting) and some uplink associated information (UAI) into a unified Layer 2 signaling scheme (e.g., increasing the amount of information included in MAC-CEs). This approach would result in MAC-CEs (in 6G) being larger in size due to the inclusion of more detailed information, such as cell information, beam information, TCI, and HARQ process granularity level data. The increased size and complexity of these MAC-CEs pose several challenges. For instance, the greater amount of in-band signaling may increase complexity for the network node 110 to accurately determine the size of the triggered MAC-CE, especially in congested network node 110 conditions. This uncertainty complicates the process of allocating the appropriate grant size for transmission. Additionally, or alternatively, the transmission of more measurements via MAC-CEs heightens the urgency of transmitting these control elements quickly. Therefore, delays in transmission due to waiting for multiple uplink grants can be reduce network node 110 communication quality of service, as timely delivery of this information is critical for network node 110 performance and reliability. Ensuring that MAC-CEs are transmitted promptly, without waiting for multiple rounds of grant allocation, is essential to maintain the efficiency and effectiveness of the network node 110.

In some aspects, the UE 120 may include a communication manager 150. As described in more detail elsewhere herein, the communication manager 150 may receive, from a network node, configuration information that configures an LCG for reporting one or more pending MAC-CEs; receive, from the network node, an uplink grant that indicates a first amount of resources configured for an uplink transmission; and transmit, to the network node, the uplink transmission, wherein the uplink transmission includes information corresponding to the LCG, and wherein the information is based at least in part on a second amount of resources of the uplink transmission allocated for the LCG.

In some aspects, the communication manager 150 may receive, from a network node, a first uplink grant that indicates a first amount of resources configured for a first uplink transmission, wherein the first amount of resources does not satisfy a data size for a MAC-CE; and transmit, to the network node, the first uplink transmission that includes a first portion of the MAC-CE, wherein the first amount of resources satisfies a data size of an initial portion of the MAC-CE. Additionally, or alternatively, the communication manager 150 may perform one or more other operations described herein.

In some aspects, the network node 110 may include a communication manager 155. As described in more detail elsewhere herein, the communication manager 155 may transmit, to a UE, configuration information that configures an LCG for reporting one or more pending MAC-CEs; transmit, to the UE, an uplink grant that indicates a first amount of resources configured for an uplink transmission; and receive, from the UE, the uplink transmission, wherein the uplink transmission includes information corresponding to the LCG, and wherein the information is based at least in part on a second amount of resources of the uplink transmission allocated for the LCG.

In some aspects, the communication manager 155 may transmit, to a UE, a first uplink grant that indicates a first amount of resources configured for a first uplink transmission, wherein the first amount of resources does not satisfy a data size for a MAC-CE; and receive, from the UE, the first uplink transmission that includes a first portion of the MAC-CE, wherein the first amount of resources satisfies a data size of an initial portion of the MAC-CE. Additionally, or alternatively, the communication manager 155 may perform one or more other operations described herein.

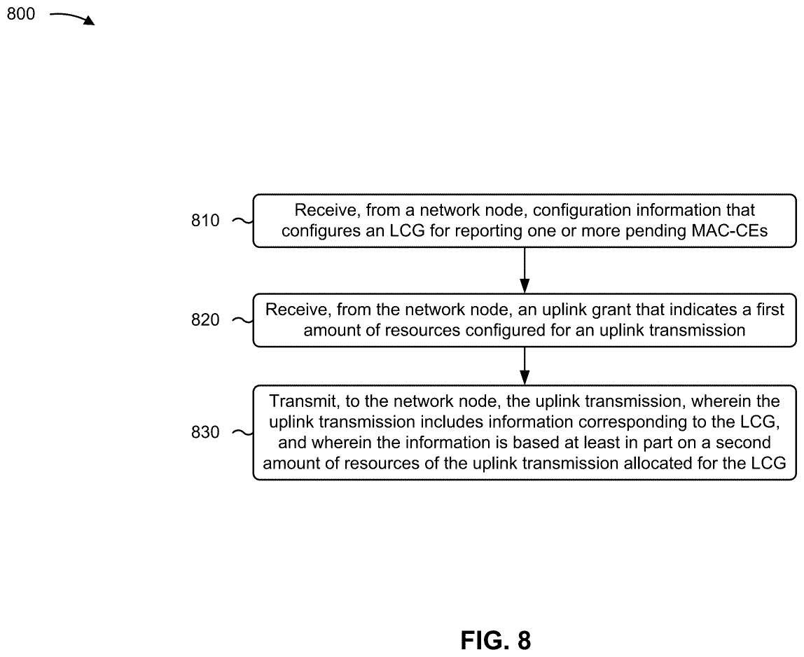

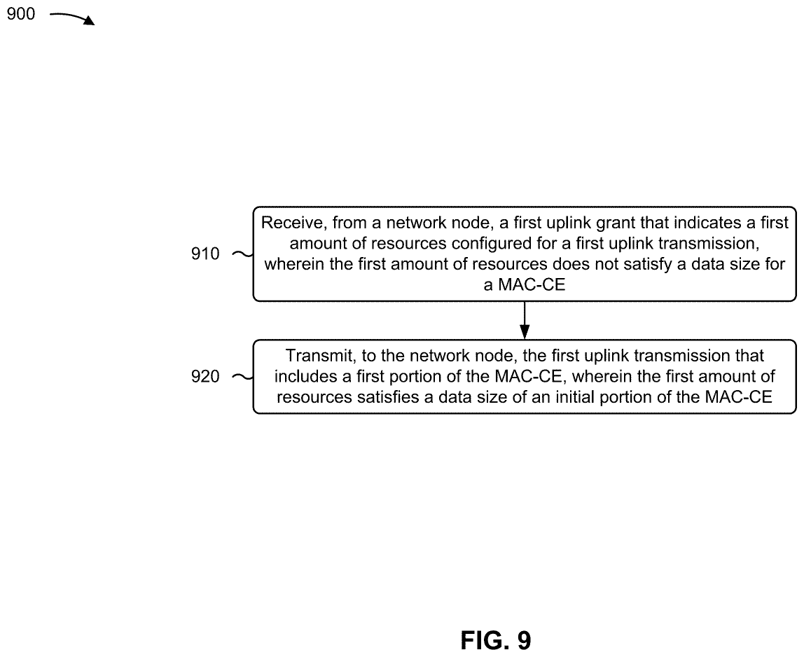

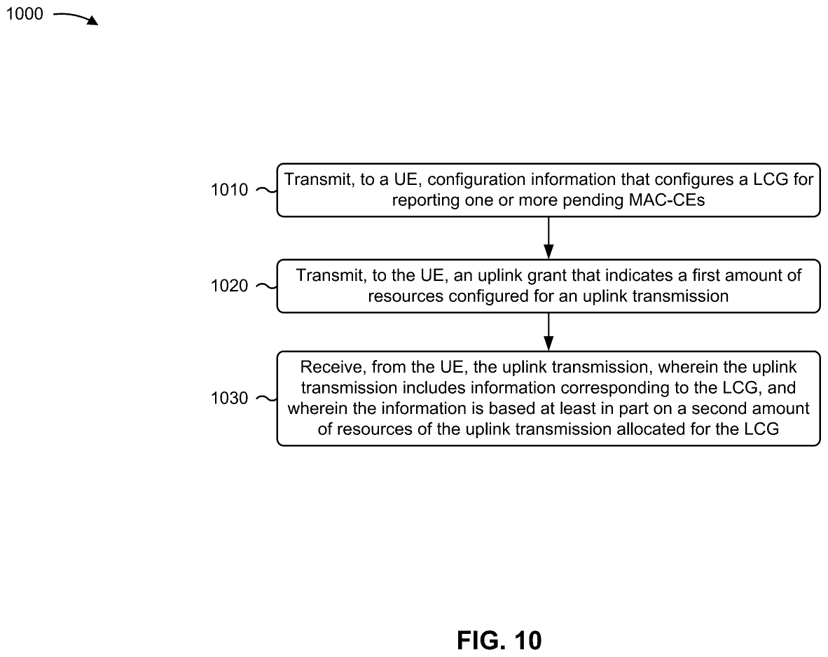

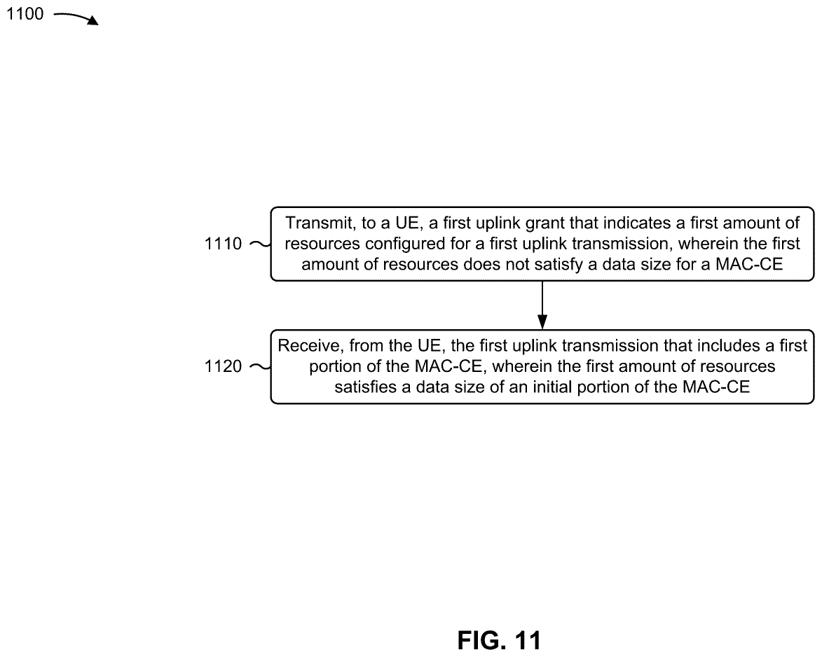

The network node 110, the processing system 145 of the network node 110, the UE 120, the processing system 140 of the UE 120, or any other component(s) of FIG. 1 may implement one or more techniques or perform one or more operations associated with transmission of MAC information according to uplink grant sizes, as described in more detail elsewhere herein. For example, the processing system 145 of the network node 110, or the processing system 140 of the UE 120 may perform or direct operations of, for example, process 800 of FIG. 8, process 900 of FIG. 9, process 1000 of FIG. 10, process 1100 of FIG. 11, or other processes as described herein (alone or in conjunction with one or more other processors). Memory of the network node 110 may store data and program code (or instructions) for the network node 110. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, or the UE 120, may cause the one or more processors to perform process 800 of FIG. 8, process 900 of FIG. 9, process 1000 of FIG. 10, process 1100 of FIG. 11, or other processes as described herein. In some examples, executing instructions may include running the instructions, converting the instructions, compiling the instructions, or interpreting the instructions, among other examples.

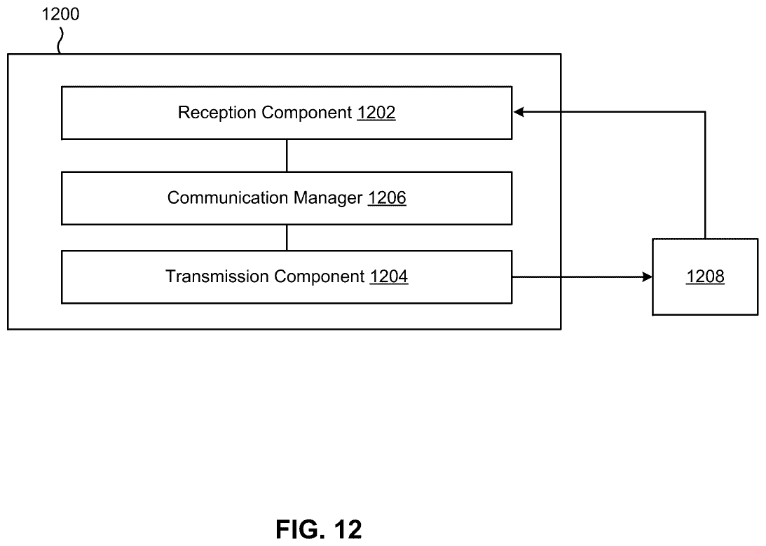

In some aspects, the UE 120 includes means for receiving, from a network node, configuration information that configures an LCG for reporting one or more pending MAC-CEs; means for receiving, from the network node, an uplink grant that indicates a first amount of resources configured for an uplink transmission; or means for transmitting, to the network node, the uplink transmission, wherein the uplink transmission includes information corresponding to the LCG, and wherein the information is based at least in part on a second amount of resources of the uplink transmission allocated for the LCG. In some aspects, the UE 120 includes means for receiving, from a network node, a first uplink grant that indicates a first amount of resources configured for a first uplink transmission, wherein the first amount of resources does not satisfy a data size for a MAC-CE; or means for transmitting, to the network node, the first uplink transmission that includes a first portion of the MAC-CE, wherein the first amount of resources satisfies a data size of an initial portion of the MAC-CE. The means for the UE 120 to perform operations described herein may include, for example, one or more of communication manager 150, processing system 140, a radio, one or more RF chains, one or more transceivers, one or more antennas, one or more modems, a reception component (for example, reception component 1202 depicted and described in connection with FIG. 12), or a transmission component (for example, transmission component 1204 depicted and described in connection with FIG. 12), among other examples.

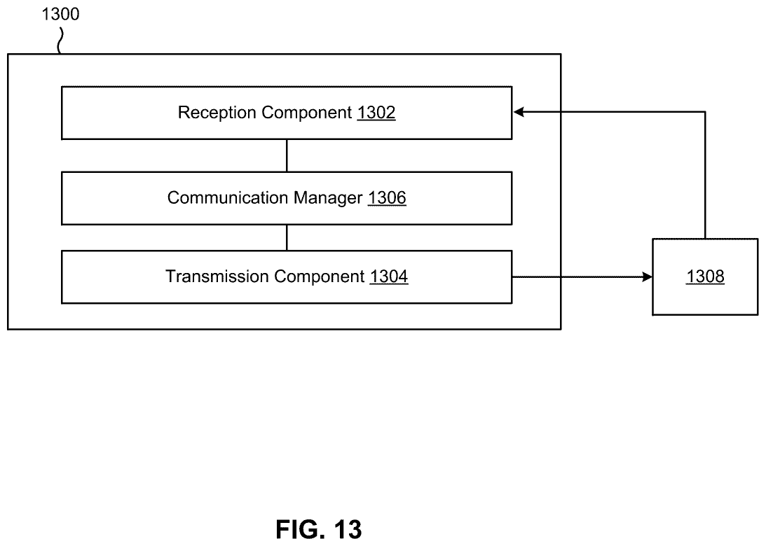

In some aspects, the network node 110 includes means for transmitting, to a UE, configuration information that configures an LCG for reporting one or more pending MAC-CEs; means for transmitting, to the UE, an uplink grant that indicates a first amount of resources configured for an uplink transmission; or means for receiving, from the UE, the uplink transmission, wherein the uplink transmission includes information corresponding to the LCG, and wherein the information is based at least in part on a second amount of resources of the uplink transmission allocated for the LCG. In some aspects, the network node 110 includes means for transmitting, to a UE, a first uplink grant that indicates a first amount of resources configured for a first uplink transmission, wherein the first amount of resources does not satisfy a data size for a MAC-CE; or means for receiving, from the UE, the first uplink transmission that includes a first portion of the MAC-CE, wherein the first amount of resources satisfies a data size of an initial portion of the MAC-CE. The means for the network node 110 to perform operations described herein may include, for example, one or more of communication manager 155, processing system 145, a radio, one or more RF chains, one or more transceivers, one or more antennas, one or more modems, a reception component (for example, reception component 1302 depicted and described in connection with FIG. 13), or a transmission component (for example, transmission component 1304 depicted and described in connection with FIG. 13), among other examples.

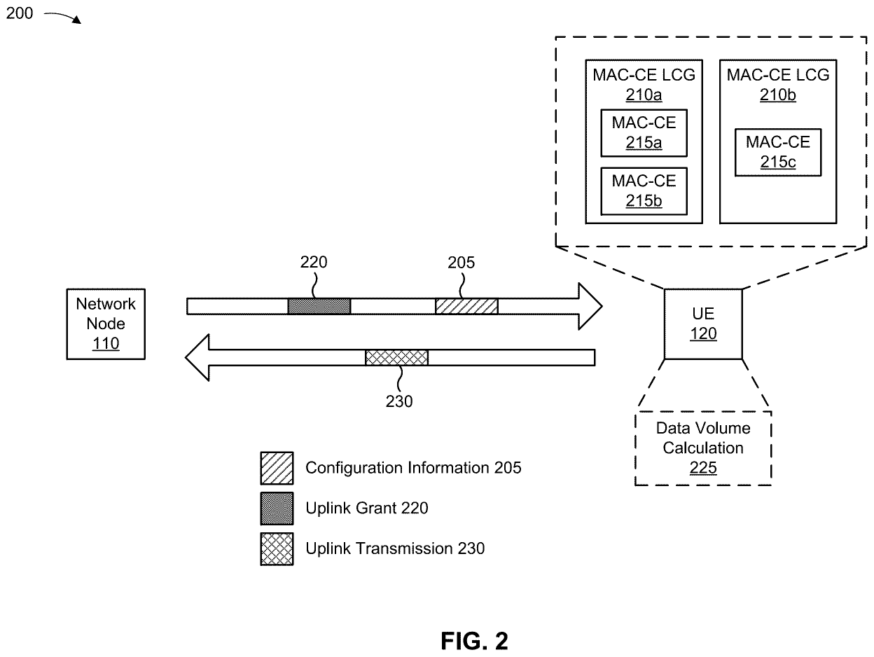

FIG. 2 is a diagram of an example 200 in accordance with configuring LCGs for buffering pending MAC-CEs 215. In some examples, FIG. 2 may implement one or more aspects of FIG. 1. For example, as shown, FIG. 2 includes the UE 120 and the network node 110 described elsewhere herein.

As shown in FIG. 2, the network node 110 may transmit, and the UE 120 may receive, configuration information 205. In some examples, the configuration information 205 may be transmitted via one or more of system information (e.g., including master information block (MIB) or SIB), RRC signaling, MAC signaling (e.g., including one or more MAC-CEs 215), or DCI signaling. Further description of the configuration information 205 is provided elsewhere herein.

In some examples, the configuration information 205 can configure one or more MAC-CE LCGs 210 (e.g., MAC-CE LCGs 210a and 210b). For example, the configuration information 205 may indicate a first LCG identifier for the MAC-CE LCG 210a and a second LCG identifier for MAC-CE LCG 210b. While example 200 includes the UE 120 being configured and allocated with two MAC-CE LCGs 210, in other examples, the configuration information 205 may indicate any number of LCG identifiers that allocate any number of MAC-CE LCGs 210.

The MAC-CE LCGs 210 may differ from other types of LCGs configured at the UE 120 (such as an LCG for data radio bearers (DRBs) or signaling radio bearers (SRBs)). For example, an LCG for DRBs is a logical grouping of channels used to carry user data in a network. The LCG for DRBs may be configured to manage data flows that have specific quality of service (QoS) characteristics, such as latency, throughput, and reliability. Each DRB within the LCG corresponds to a particular service or application, such as voice calls, video streaming, or internet browsing. Additionally, an LCG for SRBs is a logical grouping of channels dedicated to carrying control and signaling information between the UE 120 and the network node 110. These LCGs enable the establishment, maintenance, and management of the connection, by transporting signaling messages, such as RRC signaling. SRBs ensure that control information, such as connection setup, handover commands, and configuration updates, is transmitted reliably and with low latency.

Conversely to LCGs for DRBs or SRBs, the MAC-CE LCGs 210 are configured for pending MAC-CEs 215 for transmission. In other words, the UE 120 may generate one or more MAC-CEs 215 for transmission to the network node 110, where the UE 120 may buffer the MAC-CEs 215 at the MAC-CE LCGs 210 until an uplink grant 220 configures enough uplink resources for the UE 120 to transmit the MAC-CEs 215. In some examples, different MAC-CEs 215 may be mapped to different MAC-CE LCGs 210. As shown in FIG. 2, the MAC-CE 215a and 215b may be mapped to the MAC-CE LCG 210a and the MAC-CE 215c may be mapped to the MAC-CE LCG 210b. In some examples, the MAC-CE 215a may be for transmitting BSRs, the MAC-CE 215b may be for transmitting PHRs, and the MAC-CE 215c may be for transmitting LTM measurement reports. In other words, one or more MAC-CEs 215 may be mapped to a given MAC-CE LCG 210 based on the type of information that the one or more MAC-CEs 215 report or based on a priority of the one or more MAC-CEs 215. In some examples, the different MAC-CE LCGs 210 may have different priorities (e.g., the lower the LCG identifier, the higher priority for that MAC-CE LCG 210).

In some examples, the configuration information 205 may indicate the mapping between the LCGs and the MAC-CEs 215 by indicating a mapping between LCIDs and the LCGs. For instance, the various types of MAC-CEs 215 may be defined (in accordance with a wireless communication standard, such as 3GPP) with different LCIDs. For instance, the MAC-CE 215a may be defined with a first LCID, the MAC-CE 215b may be defined with a second LCID, and the MAC-CE 215c may be defined with a third LCID. Accordingly, the configuration information 205 may indicate that the first and second LCIDs are mapped to the MAC-CE LCG 210a and the third LCID is mapped to the MAC-CE LCG 210b. In some examples, the network node 110 may dynamically update the mapping between MAC-CEs 215 and MAC-CE LCGs 210 (e.g., via one or more of RRC signaling, MAC-CE 215 signaling, or DCI signaling).

As shown in FIG. 2, the network node 110 may transmit, and the UE 120 may receive, an uplink grant 220. The uplink grant 220 may provide the UE 120 with permission to transmit data on one or more indicated uplink channels. The uplink grant 220 may include information that the UE 120 uses to perform an uplink transmission 230. This information may include the uplink resource allocation, which specifies the time and frequency resources that the UE 120 can use for uplink transmission 230. The information may also include the MCS that the UE 120 should use, which determines the data rate and robustness of the uplink transmission 230. Additionally, the uplink grant 220 may indicate the power control parameters, which help the UE 120 adjust a transmission power to ensure optimal signal quality and minimize interference with other UEs or wireless devices. The signaling used to transmit the uplink grant 220 may be DCI, which is carried in a physical downlink control channel (PDCCH). The DCI format used for the uplink grant 220 includes various fields that convey the information for the uplink transmission 230. Upon receiving the DCI on the PDCCH, the UE 120 decodes the information and prepares its uplink transmission 230 according to the parameters specified in the uplink grant 220. This process ensures efficient and orderly use of uplink resources, enabling the network node 110 to manage multiple UEs and maintain high-quality communication.

After receiving the uplink grant 220, the UE 120 may perform a data volume calculation 225. For example, the UE 120 may calculate an amount of data buffered across the MAC-CE LCGs 210. In some examples, the UE 120 may calculate the sum of data of all pending MAC-CEs 215 across the multiple LCGs (e.g., the sum of all data buffered across MAC-CEs 215a through 215c). In some examples, the UE 120 may calculate the sum of data of all pending MAC-CEs 215 across a specified MAC-CE LCG 210 (e.g., if the MAC-CE LCG 210a is specified, the sum of all data buffered across MAC-CEs 215a and 215b). In some examples, the UE 120 may calculate the sum of data for specific MAC-CEs 215 (e.g., the data buffered for the MAC-CE 215b). In some examples, the configuration information 205 may indicate which MAC-CEs 215 or LCGs to consider when calculating an amount of data buffered.

Based on the data volume calculation 225, the UE 120 may determine information to include in the uplink transmission 230 scheduled by the uplink grant 220. In one example, it may be assumed that the UE 120 has determined to transmit the data of MAC-CE 215a in accordance with the data volume calculation 225. If the uplink grant 220 is available and the grant resources can accommodate the MAC-CE 215a, then the UE 120 may transmit the MAC-CE 215a in the uplink transmission 230. For instance, accommodating a MAC-CE 215 may mean that the number of available grant resources are able to carry the total data size of the MAC-CE 215.

If, however, the grant resources cannot accommodate the full MAC-CE 215a, then the UE 120 may operate in accordance with the LCG ID configuration to determine whether the grant resources can accommodate a BSR indicating the pending MAC-CEs 215. If the grant resources can accommodate a BSR indicating the pending MAC-CEs 215, then the UE 120 may transmit the BSR in the uplink transmission 230. In some examples, the size of BSR may be based on a data size that the grant resources can accommodate. For instance, if the grant resources can accommodate a full-size BSR report, then the UE 120 may transmit a full-size BSR report in the uplink transmission 230. A “full-size” BSR, also known as a long BSR, provides detailed information about the buffer status for multiple LCGs configured in the UE 120. Specifically, the full size BSR includes a buffer size field for each LCG, indicating the total amount of data, in bytes, that is currently buffered and awaiting transmission within that LCG. In some examples, the full-size BSR may indicate the data for each MAC-CE LCG 210 as well as all other LCGs configured at the UE 120 (e.g., the LCG for DRBs and the LCG for SRBs). This detailed reporting allows the network node 110 to make informed scheduling decisions, efficiently allocating uplink resources based on the actual data buffered at the UE 120. If, however, the grant resources cannot accommodate a full-size BSR report, then the UE 120 may transmit a truncated BSR in the uplink transmission 230. For instance, a truncated BSR may be a simplified version of the full-size BSR used to inform the network node 110 about the uplink data status of the UE 120 when there are limited resources available for reporting. Unlike the full size BSR, (which provides detailed buffer status for each LCG), a truncated BSR may include information about an LCG with the highest priority data that is currently buffered. Specifically, the truncated BSR may include a single buffer size field that indicates the amount of data, in bytes, buffered for the most urgent LCG. For instance, if the MAC-CE LCG 210a has the highest priority of the LCGs configured at the UE 120, then the truncated BSR may indicate the total amount of data, in bytes, buffered at the MAC-CE LCG 210a (e.g., both MAC-CEs 215a and 215b). In some examples, the truncated BSR may indicate the total amount of data, in bytes, for a subset of MAC-CEs 215 buffered at the MAC-CE LCG 210a (e.g., just MAC-CE 215a or just MAC-CE 215b).

If, however, the grant resources cannot accommodate a full MAC-CE 215 or a BSR, then the UE 120 may transmit an SR. The UE 120 may transmit the SR in the uplink transmission 230, or in separate transmissions. The SR may be a single-bit indication that requests another uplink grant from the network node 110, enabling the UE 120 to request subsequent uplink grants while reducing signaling overhead.

In some examples, if the UE 120 is unable to transmit a given MAC-CE 215 in the uplink transmission 230, the UE 120 may be able to transmit the given MAC-CE 215 in a subsequent uplink transmission 230 scheduled by a subsequent uplink grant 220. After transmission of the given MAC-CE 215, the UE 120 may cancel any pending BSRs or any pending SRs for that given MAC-CE 215.

In some examples, the configuration information 205 may indicate and configure different SR configurations for different MAC-CEs 215, different MAC-CE LCGs 210, different logical channels of the MAC-CE LCGs 210, or a combination thereof. An SR configuration may include one or more parameters, including one or more of an SR periodicity (e.g., how often the UE 120 is allowed to send an SR), SR resources (e.g., specific time and frequency resources on a PUCCH, that the UE 120 should use to transmit the SR), an SR configuration index (e.g., an index is used to map the SR periodicity and resource allocation to specific PUCCH resources), an SR prohibit timer (e.g., a period during which the UE 120 is prohibited from sending another SR after a previous SR has been transmitted), or a logical channel SR masking (e.g., indicates whether SRs are enabled or disabled for specific logical channels of a MAC-CE LCG 210).

In some examples, the uplink transmission 230 may include a padding BSR. For instance, a padding BSR is a type of BSR to fill unused space in a MAC protocol data unit (PDU) with control information, ensuring efficient utilization of the available uplink resources. Padding BSRs may be employed if the UE 120 has some remaining space in a MAC PDU after including all of the scheduled data and other control information, but this space is insufficient to carry additional user data. Instead of leaving the space unused, the UE 120 can insert a padding BSR to inform the network about a buffer status at the UE 120. The padding BSR may be a truncated BSR (described elsewhere herein), which provides a concise report indicating the amount of data buffered for a highest priority MAC-CE LCG 210 that has data waiting to be transmitted. In some examples, the UE 120 may prioritize using the truncated BSR over a full-size BSR for the padding BSR. By utilizing padding BSRs, the network node 110 can optimize resource allocation and maintain high levels of spectral efficiency, ultimately enhancing overall network performance.

In some examples, a MAC-CE 215 may be delay sensitive. For instance, the LTM measurement report (in the MAC-CE 215c) may lose relevancy the longer the report is buffered at the UE 120. Accordingly, if a MAC-CE 215 includes delay sensitive data (e.g. data that has a configured expiration time), the UE 120 may transmit in the uplink transmission 230 a delay status report (DSR). For instance, a DSR may be a mechanism used to address applications or services that communicate low latency and timely data transmission. The DSR may be designed to promptly inform the network node 110 about the presence of delay-sensitive data in the buffer of the UE 120. Conversely to the BSR (which provides an overview of the buffer status for various LCGs), the DSR focuses on the urgency of the data. The DSR may be triggered by specific conditions, such as the arrival of high-priority, low-latency data, and the UE 120 may transmit the DSR using dedicated resources to ensure immediate attention from the network node 110. This allows the network node 110 to prioritize the allocation of uplink resources for delay-sensitive traffic, ensuring that such data is transmitted with minimal delay. Additionally, the DSR may indicate an amount of data for one or more MAC-CEs 215 or for data stored at one or more MAC-CE LCGs 210, and may indicate an amount of time before the data may no longer be relevant (e.g., data expiration).

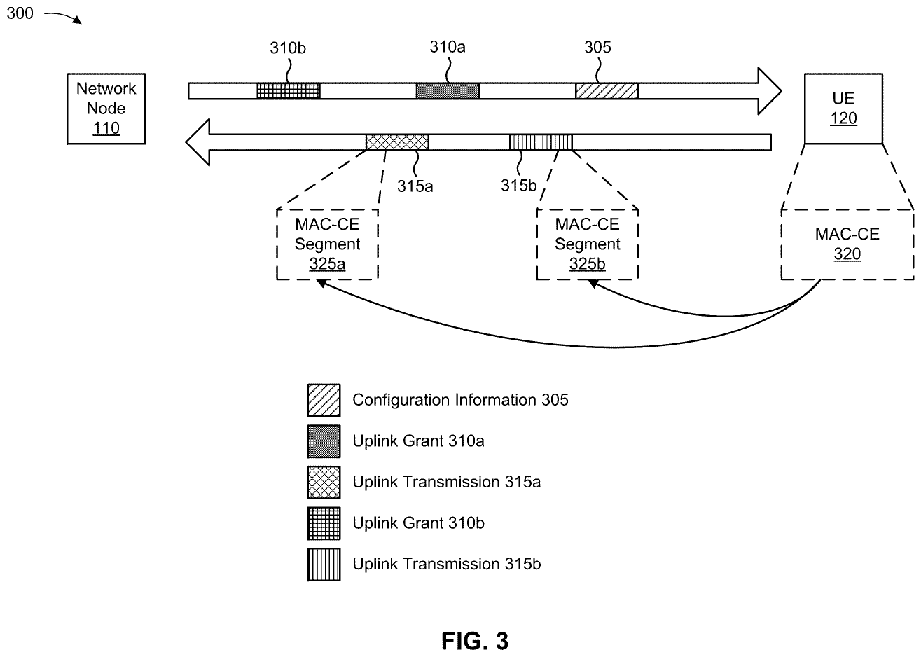

FIG. 3 is a diagram of an example 300 in accordance with transmitting multiple segments of a MAC-CE across multiple uplink transmissions. In some examples, FIG. 3 may implement one or more aspects of FIGS. 1 and 2. For example, as shown, FIG. 3 includes the UE 120 and the network node 110 described elsewhere herein.

As shown in FIG. 3, the network node 110 may transmit, and the UE 120 may receive, configuration information 305. In some examples, the configuration information 305 may be transmitted via one or more of system information (e.g., including MIB or SIB), RRC signaling, MAC signaling (e.g., including one or more MAC-CEs), or DCI signaling. Further description of the configuration information 305 is provided elsewhere herein. In some examples, the configuration information 305 may enable the UE to segment one or more MAC-CEs into MAC-CE segments 325 for transmission across multiple uplink transmissions 315.

As shown in FIG. 3, the network node 110 may transmit, and the UE 120 may receive, one or more uplink grants 310 (e.g., uplink grants 310a and 310b). As described elsewhere herein, an uplink grant 310 may provide the UE 120 with permission to transmit data on one or more indicated uplink channels. In some examples, the uplink grants 310 may be the same as or include similar aspects to the uplink grant 220.

The UE 120 may receive the uplink grant 310a, and accordingly, may determine information to include in an uplink transmission 315 scheduled by the uplink grant 310a. For example, as shown in FIG. 3, the UE 120 may generate and have a MAC-CE 320 pending for transmission to the network node 110. Accordingly, the UE 120 may determine whether the grant resources indicated by the uplink grant 310a can accommodate the MAC-CE 320. For instance, accommodating the MAC-CE 320 may mean that the number of available grant resources are able to carry the total data size of the MAC-CE 320.

If, however, the grant resources of the uplink grant 310a cannot accommodate the full MAC-CE 320, then the UE 120 may segment the MAC-CE 320 into multiple MAC-CE segments 325 (e.g., MAC-CE segments 325a and 325b) such that the UE 120 may transmit the entire MAC-CE 320 over multiple uplink transmissions 315. For instance, the UE 120 may generate the MAC-CE segment 325a which includes an initial portion of the data from the MAC-CE 320. In some examples, a data size of the MAC-CE segment 325a (e.g., the amount of initial data from the MAC-CE 320) may be based on the amount of data that the grant resources of uplink grant 310a can accommodate. For instance, if the amount of grant resources allows the UE 120 to transmit x-bytes of information, then the data size of the MAC-CE segment 325a may be less than or equal to x-bytes.

Accordingly, the UE 120 may wait for subsequent uplink grant 310 to transmit another segment of the MAC-CE 320. For instance, after transmitting the uplink transmission 315a that includes the MAC-CE segment 325a, the network node 110 may transmit, and the UE 120 may receive, the uplink grant 310b that may configure grant resources for the UE 120 to transmit an uplink transmission 315b. Accordingly, the UE 120 may generate the MAC-CE segment 325b, which includes another portion of the data from the MAC-CE 320 (different than the MAC-CE segment 325a). In some examples, a data size of the MAC-CE segment 325b may be based on the amount of data that the grant resources of uplink grant 310b can accommodate. For instance, if the amount of grant resources of uplink grant 310b allows the UE 120 to transmit y-bytes of information, then the data size of the MAC-CE segment 325a may be less than or equal to y-bytes. In example 300, the remaining data of MAC-CE 320 after transmitting the MAC-CE segment 325a may be z-bytes, where z<y. Accordingly, in example 300, the MAC-CE segment 325b may include the remaining data of MAC-CE 320. In other examples, however, there may still be a portion of the MAC-CE 320 that has not been transmitted after the uplink transmission 315b. In such other examples, the UE 120 may transmit one or more subsequent uplink transmissions 315 scheduled by one or more subsequent uplink grants 310 until the full MAC-CE 320 is transmitted over a number of MAC-CE segments 325. Therefore, the techniques described herein enable the UE 120 to segment the MAC-CE 320 to transmit multiple MAC-CE segments 325 over multiple uplink transmissions 315 scheduled by consecutive uplink grants 310.

The UE 120 may indicate the segmentation of the MAC-CE 320 in accordance with one or more techniques. In some examples, the UE 120 may indicate different sequence numbers for different MAC-CE segments 325, where the sequence numbers serve as segmentation headers. For instance, the UE 120 may assign each MAC-CE segment 325 of the MAC-CE 320 a unique sequence number that indicates the position of the MAC-CE segment 325 within the MAC-CE 320. When the UE 120 transmits a MAC-CE segment 325 of the MAC-CE 320, the UE 120 includes the sequence number in the uplink transmission 315. This sequence number provides the network node 110 with information about the order of the MAC-CE segment 325, enabling the network node 110 to correctly reconstruct the MAC-CE 320. In some examples, a given uplink transmission 315 may include metadata that specifies the total size of the MAC-CE 320 and the size of the MAC-CE segment 325 being transmitted in the given uplink transmission 315. This metadata helps the network node 110 to verify the completeness of the received segments and detect any missing or out-of-order segments. For instance, in example 300, the uplink transmission 315a may include a sequence number indicating that the MAC-CE segment 325a is the first segment, along with metadata specifying the total message size of MAC-CE 320 and the size of the MAC-CE segment 325a. Additionally, the uplink transmission 315b may include a sequence number indicating that the MAC-CE segment 325b is the second segment, along with metadata specifying the total message size of MAC-CE 320 and the size of the MAC-CE segment 325b. By using sequence numbers and accompanying metadata, the network node 110 can accurately interpret each MAC-CE segment 325 and reassemble the complete MAC-CE 320, ensuring reliable communication across multiple uplink transmissions 315 and maintaining MAC-CE security across the MAC-CE segments 325. In some examples, the configuration information 305 may indicate that the UE 120 is allowed to use sequence numbering to indicate the MAC-CE segments 325.

In some examples, the initial MAC-CE segment 325 (e.g., MAC-CE segment 325a) may include an indication of segmentation (e.g., a segmentation indicator) with later segmentation arriving in subsequent uplink transmissions 315 scheduled by subsequent uplink grants 310. In some examples, the presence of this segmentation indicator indicates truncation of the MAC-CE 320 and indicates that the UE 120 may transmit subsequent MAC-CE segments 325. For example, the MAC-CE segment 325a may include the segmentation indicator, indicating that the MAC-CE segment 325a is an initial portion of the MAC-CE 320 and that subsequent MAC-CE segments 325 may be transmitted in subsequent uplink transmissions 315. In some examples, absence of this segmentation indicator in a given uplink transmission 315 indicates that the given uplink transmission 315 includes a complete MAC-CE or indicates that the given uplink transmission 315 includes a last segment of the MAC-CE 320. For example, the MAC-CE segment 325b may not include the segmentation indicator, indicating that the MAC-CE segment 325b is the final segment of the MAC-CE 320. The network node 110 may understand that the MAC-CE segment 325b is a final segment of MAC-CE 320 rather than a different and separate MAC-CE because the MAC-CE segment 325a and the MAC-CE segment 325b both share the same LCID. Therefore, the combination of the segmentation indicator and the LCID enables the UE 120 to indicate whether an uplink transmission 315 includes a MAC-CE segment 325 or an entire MAC-CE 320.

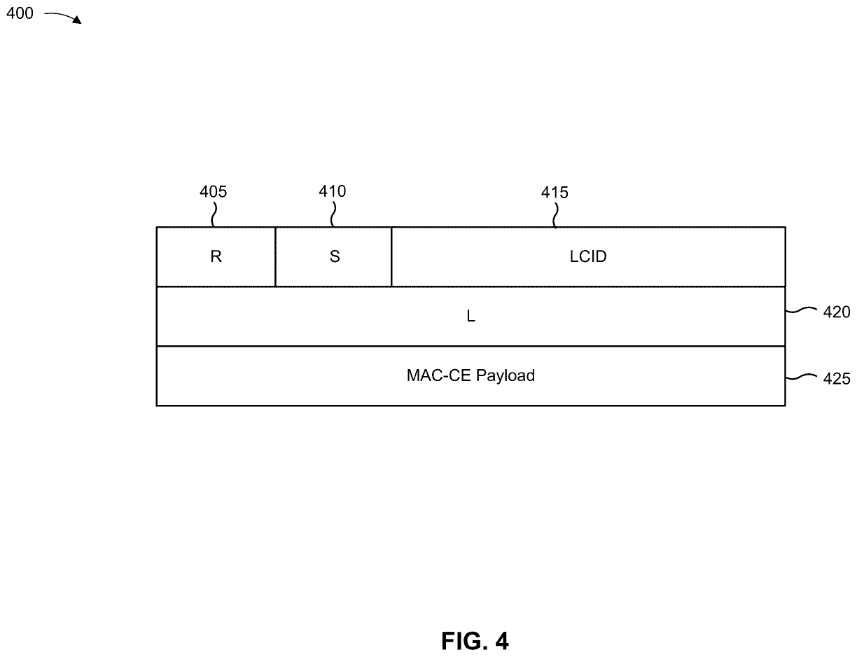

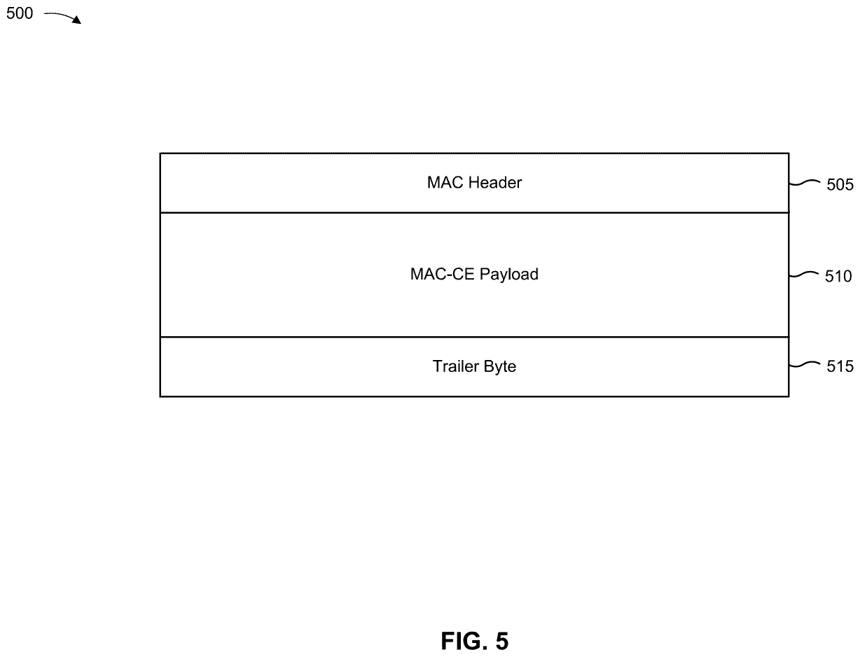

In some examples, the segmentation indicator may be included in the MAC header of an uplink transmission 315. Further discussion of the indicator for segmentation in the MAC header is provided elsewhere herein (such as with reference to FIG. 4). In some examples, the segmentation indicator may be included as a trailer byte at the end of a MAC-CE segment 325. Further discussion of the indicator for segmentation being a trailer byte is provided elsewhere herein (such as with reference to FIG. 5).

FIG. 4 is a diagram of an example 400 in accordance with indicating a MAC-CE segment of a MAC-CE. In some examples, FIG. 4 may show operations that implement one or more aspects of FIGS. 1 through 3. For example, as shown, FIG. 4 illustrates one or more fields included in a MAC-CE segment 325. For example, the MAC-CE segment 325 may include one or more of a reserved bit field 405, a segment indicator field 410, an LCID field 415, a length field 420, and a MAC-CE payload field 425.

The reserved bit field 405 may be a length of 1 bit that is reserved and may be ignored, unless configured otherwise. In some examples, the MAC-CE segment 325 may include multiple reserved bit fields 405.

The segment indicator field 410 may be an example of a reserved bit in the MAC header of the MAC-CE segment 325 that has been configured to indicate segmentation of a MAC-CE. For instance, if the segment indicator is set to a first value (e.g., “1”) then the segment indicator field 410 indicates that the included MAC-CE payload is a portion (e.g., a segment) of a MAC-CE (e.g., indicates the MAC-CE segment 325). Accordingly, if a MAC-CE is separated into N total MAC-CE segments 325, the first N-1 MAC-CE segments 325 may include the first value. If the segment indicator is set to a second value (e.g., “0”), then the segment indicator field 410 indicates that the included MAC-CE payload is a last portion (e.g., N-th or last segment) of the MAC-CE.

The LCID field 415 may include a set of bits (e.g., 6 bits) that indicates the LCID corresponding to the MAC-CE segment 325. Accordingly, the network node 110 may use the combination of the segment indicator field 410 and the LCID field 415 to determine whether an uplink message includes a MAC-CE segment 325, a final MAC-CE segment 325, or a full MAC-CE.

The length field 420 may indicate a length of the MAC-CE payload field 425 (e.g., a number of bytes included in the MAC-CE payload field 425).

The MAC-CE payload field 425 may include the payload corresponding to the MAC-CE segment 325.

FIG. 5 is a diagram of an example 500 in accordance with indicating a MAC-CE segment of a MAC-CE. In some examples, FIG. 5 may implement one or more aspects of FIGS. 1 through 4. For example, as shown, FIG. 5 illustrates one or more fields included in a MAC-CE segment 325. For example, the MAC-CE segment 325 may include a MAC header 505, a MAC-CE payload field 510, and a trailer byte 515.

The MAC header may include one or more fields of the MAC-CE segment as described elsewhere herein (e.g., one or more reserved bit fields, an LCID field, a length field, among other examples).

The MAC-CE payload filed 510 may include the payload corresponding to the MAC-CE segment 325.

The trailer byte 515 may include a set of bits (e.g., 8 bits) that indicate segmentation. As shown in FIG. 5, the trailer byte 515 may be at the end of the MAC-CE segment 325. In some examples, the value of the trailer byte 515 may indicate that the MAC-CE segment 325 of the MAC-CE payload field 510 is a portion of a full MAC-CE. Accordingly, if a MAC-CE is separated into N total MAC-CE segments 325, the first N-1 MAC-CE segments 325 may include the trailer byte 515. Additionally, the N-th MAC-CE segment 325 (e.g., the last segment) may not include the trailer byte 515, indicating to the network node that the full MAC-CE has been sent. In some examples, the configuration information 305 may enable the UE 120 to use the trailer byte 515. In some examples, the configuration information 305 may indicate a value of the trailer byte 515 such that both the network node 110 and the UE 120 are aware of the value.

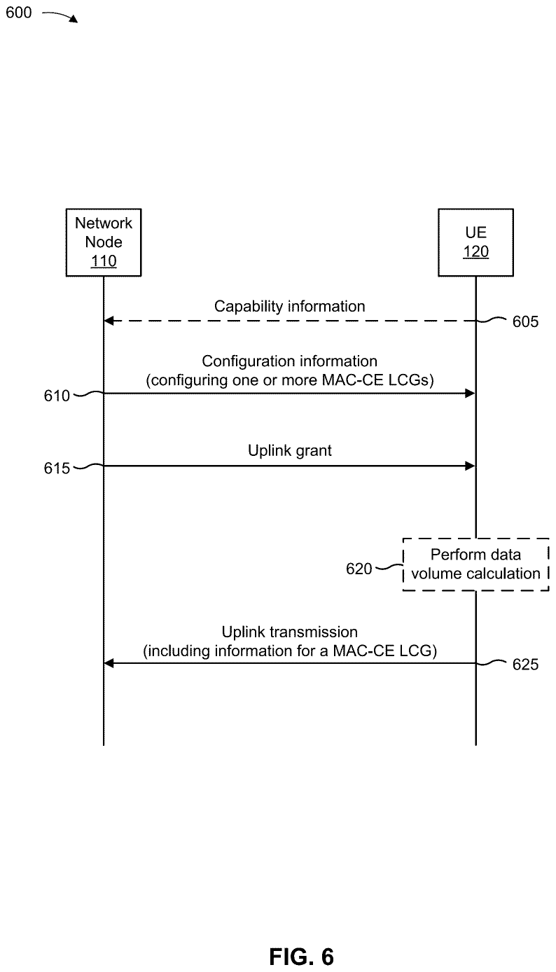

FIG. 6 is a diagram illustrating an example 600 associated with signaling that enables one or more LCGs for the communication of MAC-CEs. Example 600 may implement or be implemented by one or more aspects of FIGS. 1 and 2. For instance, example 600 includes wireless communications between the network node 110 and the UE 120. Alternative examples of the following may be implemented, where some operations are performed in a different order than described, or not described at all. In some cases, one or more operations may include additional features not mentioned below, or further operations may be added. In addition, while example 600 shows operations between the UE 120 and the network node 110, the communications may occur between any number of network devices of various types described herein.

In a first operation 605, the UE 120 may optionally transmit, and the network node 110 may receive, capability information. The capability information may be included in a capability report. The UE 120 may transmit the capability information via an uplink communication, a sidelink communication, a unicast communication, a broadcast communication, a UE assistance information (UAI) communication, a UCI communication, a sidelink control information (SCI) communication, a MAC-CE communication, an RRC communication, a PUCCH, a PUSCH, a sidelink channel (e.g., a physical sidelink control channel (PSCCH), or a physical sidelink shared channel (PSSCH)), among other examples. The capability information may indicate one or more parameters associated with respective capabilities of the UE 120. The one or more parameters may be indicated via respective IEs included in a capability report.

The capability information may indicate whether the UE 120 supports a feature or one or more parameters related to the feature. For example, the capability information may indicate a capability of the UE 120 to support LCGs for reporting one or more opening MAC-CEs. In other words, the capability information may indicate that the UE 120 is capable of operating in accordance with one or more MAC-CE LCGs 210, as described elsewhere herein. One or more operations described herein may be based on the capability information. For example, the UE 120 may perform one or more operations of example 600 in accordance with the capability information or may receive one or more of configuration information or control information that is in accordance with the capability information. The network node 110 may determine configuration information for the UE 120 based on the capability information.

In a second operation 610, the network node 110 may transmit, and the UE 120 may receive, the configuration information (e.g., the configuration information 205). In some aspects, the UE 120 may receive the configuration information via one or more of system information signaling (e.g., a MIB or a SIB, among other examples), RRC signaling, MAC signaling (e.g., one or more MAC-CEs), or DCI, among other examples.

In some aspects, the configuration information may indicate one or more candidate configurations or communication parameters. In some aspects, the one or more candidate configurations or communication parameters may be selected, activated, or deactivated by a subsequent indication. For example, the subsequent indication may indicate a candidate configuration or communication parameter from the one or more candidate configurations or communication parameters. In some aspects, the subsequent indication may include a dynamic indication, such as one or more MAC-CEs or one or more DCI messages, among other examples.

In some examples, the configuration information may not be expressly signaled to the UE 120. For example, in some aspects, the configuration information may at least partially be defined by a wireless communication standard, such as the 3GPP. In such examples, the network node 110 may not explicitly indicate such configuration information to the UE 120. For example, the UE 120 may optionally obtain at least a portion of the configuration information from a configuration stored by the UE 120 (e.g., an original equipment manufacturer (OEM) configuration). In some aspects, the configuration information may include a parameter or index that is indicative of information defined, or otherwise fixed, by a wireless communication standard, such as the 3GPP (e.g., rather than explicitly indicating the information).

In some examples, the configuration information configures an LCG for reporting one or more pending MAC-CEs (e.g., configuration for a MAC-CE LCG 210). In some examples, the configuration information indicates multiple LCGs for reporting the one or more pending MAC-CEs, where the LCG may be a first LCG of the multiple LCGs (e.g., MAC-CE LCG 210a) that includes one or more first MAC-CEs, and a second LCG of the multiple LCGs (e.g., MAC-CE LCG 210b) includes one or more second MAC-CEs. In some examples, the configuration information indicates one or more SR configurations respectively assigned to the one or more pending MAC-CEs at the LCG.

In a third operation 615, the network node 110 may transmit, and the UE 120 may receive, an uplink grant that indicates a first amount of resources configured for an uplink transmission. For example, the uplink grant may be an example of the uplink grant 220.

In a fourth operation 620, the UE 120 may optionally perform a data volume calculation for MAC-CE data buffered at the LCG, where the data volume calculation may be based on the one or more pending MAC-CEs or a subset of the one or more pending MAC-CEs that is indicated in the configuration information. For example, the UE 120 may perform the data volume calculation 225.

In a fifth operation 625, the UE 120 may transmit, and the network node 110 may receive, an uplink transmission (e.g., the uplink transmission 230). For example, the uplink transmission may include information corresponding to the LCG, where the information may be based on a second amount of resources of the uplink transmission allocated for the LCG.

In some examples, the information included in the uplink transmission includes a MAC-CE buffering at the LCG based on the second amount of resources satisfying a size of the MAC-CE. For example, to “satisfy a size” of the MAC-CE, the amount of resources of the uplink resources may be large enough to accommodate or carry the data included in the MAC-CE.

In some examples, the information included in the uplink transmission includes a BSR that indicates pending MAC-CE data that is buffered at the LCG based on the second amount of resources not satisfying a size of the pending MAC-CE data. For example, the BSR may be a full-size BSR if the second amount of resources satisfies a size of the full-size BSR. Alternatively, the BSR may be a truncated BSR if the second amount of resources satisfies a size of the truncated BSR and does not satisfy a size of a full-size BSR.

In some examples, the information included in the uplink transmission includes a scheduling request based on the second amount of resources not satisfying a size of pending MAC-CE data that is buffered at the LCG and not satisfying a size of a BSR to indicate the pending MAC-CE data.

In some examples, the information included in the uplink transmission includes a padding BSR that indicates pending MAC-CE data that is buffered at the LCG based on the first amount of resources configured for the uplink transmission.

In some examples, the information included in the uplink transmission includes a delay status report that indicates pending MAC-CE data that is buffered at the LCG and a time at which the pending MAC-CE data expires.

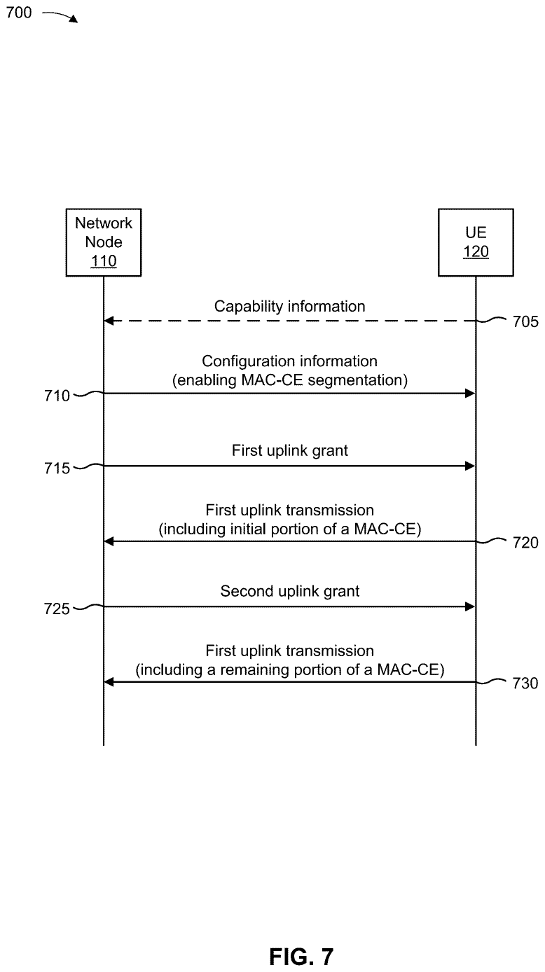

FIG. 7 is a diagram illustrating an example 700 associated with signaling that enables segmenting a MAC-CE across multiple uplink transmissions. Example 700 may implement or be implemented by one or more aspects of FIGS. 1 through 5. For instance, example 700 includes wireless communications between the network node 110 and the UE 120. Alternative examples of the following may be implemented, where some operations are performed in a different order than described, or not described at all. In some cases, one or more operations may include additional features not mentioned below, or further operations may be added. In addition, while example 700 shows operations between the UE 120 and the network node 110, the communications may occur between any number of network devices of various types described herein.

In a first operation 705, the UE 120 may optionally transmit, and the network node 110 may receive, capability information. The capability information may be included in a capability report. The UE 120 may transmit the capability information via an uplink communication, a sidelink communication, a unicast communication, a broadcast communication, a UAI communication, a UCI communication, an SCI communication, a MAC-CE communication, an RRC communication, a PUCCH, a PUSCH, a sidelink channel (e.g., a PSCCH, or a PSSCH), among other examples. The capability information may indicate one or more parameters associated with respective capabilities of the UE 120. The one or more parameters may be indicated via respective IEs included in a capability report.

The capability information may indicate whether the UE 120 supports a feature or one or more parameters related to the feature. For example, the capability information may indicate a capability of the UE 120 to support segmenting a MAC-CE into multiple MAC-CE segments for transmission across multiple uplink transmissions. In other words, the capability information may indicate that the UE 120 is capable of segmenting the MAC-CE 320 into multiple MAC-CE segments 325. One or more operations described herein may be based on the capability information. For example, the UE 120 may perform one or more operations of example 700 in accordance with the capability information or may receive one or more of configuration information or control information that is in accordance with the capability information. The network node 110 may determine configuration information for the UE 120 based on the capability information.

In a second operation 710, the network node 110 may transmit, and the UE 120 may receive, the configuration information (e.g., the configuration information 305). In some aspects, the UE 120 may receive the configuration information via one or more of system information signaling (e.g., a MIB or a SIB, among other examples), RRC signaling, MAC signaling (e.g., one or more MAC-CEs), or DCI, among other examples.

In some aspects, the configuration information may indicate one or more candidate configurations or communication parameters. In some aspects, the one or more candidate configurations or communication parameters may be selected, activated, or deactivated by a subsequent indication. For example, the subsequent indication may indicate a candidate configuration or communication parameter from the one or more candidate configurations or communication parameters. In some aspects, the subsequent indication may include a dynamic indication, such as one or more MAC-CEs or one or more DCI messages, among other examples.

In some examples, the configuration information may not be expressly signaled to the UE 120. For example, in some aspects, the configuration information may at least partially be defined by a wireless communication standard, such as the 3GPP. In such examples, the network node 110 may not explicitly indicate such configuration information to the UE 120. For example, the UE 120 may optionally obtain at least a portion of the configuration information from a configuration stored by the UE 120 (e.g., an OEM configuration). In some aspects, the configuration information may include a parameter or index that is indicative of information defined, or otherwise fixed, by a wireless communication standard, such as the 3GPP (e.g., rather than explicitly indicating the information).

In some examples, the configuration information enables a segmentation of MAC-CEs across multiple uplink transmissions, where a first uplink transmission may include an initial portion of the MAC-CE based on the configuration information.

In a third operation 715, the network node 110 may transmit, and the UE 120 may receive, a first uplink grant (e.g., the uplink grant 310a) that indicates a first amount of resources configured for a first uplink transmission. In some examples, the first amount of resources does not satisfy a data size for a MAC-CE at the UE 120. For example, “not satisfying a data size” of the MAC-CE may refer to amount of resources of the uplink resources not being large enough to accommodate or carry the data included in the MAC-CE.

In a fourth operation 720, the UE 120 may transmit, and the network node 110 may receive, first uplink transmission (e.g., the uplink transmission 315a) that includes a first portion of the MAC-CE (e.g., the MAC-CE segment 325a), where the first amount of resources satisfies a data size of an initial portion of the MAC-CE.

In some examples, the first uplink transmission includes a segmentation header that indicates that the initial portion of the MAC-CE is a segment of the MAC-CE. In some examples, the initial portion of the MAC-CE includes an indication of segmentation indicating that one or more remaining portions of the MAC-CE will be transmitted in one or more subsequent uplink transmissions. In one example, the indication of segmentation may include a bit in a MAC header of the initial portion of the MAC-CE, where the bit indicates whether the initial portion of the MAC-CE is a segment of the MAC-CE, a full payload of the MAC-CE, or a last segment of the MAC-CE (e.g., the segment indicator field 410). In another example, the indication of segmentation comprises a trailer byte at an end of the initial portion of the MAC-CE (e.g., the trailer byte 515).

In a fifth operation 725, the network node 110 may transmit, and the UE 120 may receive, a second uplink grant (e.g., the uplink grant 310b) that indicates a second amount of resources configured for a second uplink transmission, where the second amount of resources satisfies a data size of a remaining portion of the MAC-CE.

In a sixth operation 730, the UE 120 may transmit, and the network node 110 may receive, the second uplink transmission (e.g., the uplink transmission 315b) that includes the remaining portion of the MAC-CE (e.g., the MAC-CE segment 325b) based on the second amount of resources satisfying a data size of the remaining portion of the MAC-CE.

FIG. 8 is a diagram illustrating an example process 800 performed, for example, at a UE or an apparatus of a UE. Example process 800 is an example where the apparatus or the UE (e.g., UE 120) performs operations associated with transmission of medium access control information according to uplink grant sizes.

As shown in FIG. 8, in some aspects, process 800 may include receiving, from a network node, configuration information that configures an LCG for reporting one or more pending MAC-CEs (block 810). For example, the UE (e.g., using reception component 1202 or communication manager 1206, depicted in FIG. 12) may receive, from a network node, configuration information that configures an LCG for reporting one or more pending MAC-CEs, as described above.

As further shown in FIG. 8, in some aspects, process 800 may include receiving, from the network node, an uplink grant that indicates a first amount of resources configured for an uplink transmission (block 820). For example, the UE (e.g., using reception component 1202 or communication manager 1206, depicted in FIG. 12) may receive, from the network node, an uplink grant that indicates a first amount of resources configured for an uplink transmission, as described above.

As further shown in FIG. 8, in some aspects, process 800 may include transmitting, to the network node, the uplink transmission, where the uplink transmission includes information corresponding to the LCG, and the information is based at least in part on a second amount of resources of the uplink transmission allocated for the LCG (block 830). For example, the UE (e.g., using transmission component 1204 or communication manager 1206, depicted in FIG. 12) may transmit, to the network node, the uplink transmission, where the uplink transmission includes information corresponding to the LCG, and the information is based at least in part on a second amount of resources of the uplink transmission allocated for the LCG, as described above.

Process 800 may include additional aspects, such as any single aspect or any combination of aspects described below or in connection with one or more other processes described elsewhere herein.

In a first aspect, process 800 includes performing a data volume calculation for MAC-CE data buffered at the LCG, where the data volume calculation is based at least in part on the one or more pending MAC-CEs or a subset of the one or more pending MAC-CEs that is indicated in the configuration information.

In a second aspect, alone or in combination with the first aspect, the configuration information indicates multiple LCGs for reporting the one or more pending MAC-CEs, where the LCG is a first LCG of the multiple LCGs that includes one or more first MAC-CEs and a second LCG of the multiple LCGs includes one or more second MAC-CEs.

In a third aspect, alone or in combination with one or more of the first and second aspects, the information included in the uplink transmission comprises a MAC-CE buffering at the LCG based at least in part on the second amount of resources satisfying a size of the MAC-CE.

In a fourth aspect, alone or in combination with one or more of the first through third aspects, the information included in the uplink transmission comprises a BSR that indicates pending MAC-CE data that is buffered at the LCG based at least in part on the second amount of resources not satisfying a size of the pending MAC-CE data.

In a fifth aspect, alone or in combination with one or more of the first through fourth aspects, the BSR is a full-size BSR based at least in part on the second amount of resources satisfying a size of the full-size BSR.

In a sixth aspect, alone or in combination with one or more of the first through fifth aspects, the BSR is a truncated BSR based at least in part on the second amount of resources satisfying a size of the truncated BSR and not satisfying a size of a full-size BSR.

In a seventh aspect, alone or in combination with one or more of the first through sixth aspects, the information included in the uplink transmission comprises a scheduling request based at least in part on the second amount of resources not satisfying a size of pending MAC-CE data that is buffered at the LCG and not satisfying a size of a BSR to indicate the pending MAC-CE data.

In an eighth aspect, alone or in combination with one or more of the first through seventh aspects, the configuration information indicates one or more scheduling request configurations respectively assigned to the one or more pending MAC-CEs at the LCG.

In a ninth aspect, alone or in combination with one or more of the first through eighth aspects, the information included in the uplink transmission comprises a padding BSR that indicates pending MAC-CE data that is buffered at the LCG based at least in part on the first amount of resources configured for the uplink transmission.

In a tenth aspect, alone or in combination with one or more of the first through ninth aspects, the information included in the uplink transmission comprises a delay status report that indicates pending MAC-CE data that is buffered at the LCG and a time at which the pending MAC-CE data expires.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, at a UE or an apparatus of a UE. Example process 900 is an example where the apparatus or the UE (e.g., UE 120) performs operations associated with transmission of medium access control information according to uplink grant sizes.

As shown in FIG. 9, in some aspects, process 900 may include receiving, from a network node, a first uplink grant that indicates a first amount of resources configured for a first uplink transmission, where the first amount of resources does not satisfy a data size for a MAC-CE (block 910). For example, the UE (e.g., using reception component 1202 or communication manager 1206, depicted in FIG. 12) may receive, from a network node, a first uplink grant that indicates a first amount of resources configured for a first uplink transmission, where the first amount of resources does not satisfy a data size for a MAC-CE, as described above.

As further shown in FIG. 9, in some aspects, process 900 may include transmitting, to the network node, the first uplink transmission that includes a first portion of the MAC-CE, where the first amount of resources satisfies a data size of an initial portion of the MAC-CE (block 920). For example, the UE (e.g., using transmission component 1204 or communication manager 1206, depicted in FIG. 12) may transmit, to the network node, the first uplink transmission that includes a first portion of the MAC-CE, where the first amount of resources satisfies a data size of an initial portion of the MAC-CE, as described above.

Process 900 may include additional aspects, such as any single aspect or any combination of aspects described below or in connection with one or more other processes described elsewhere herein.

In a first aspect, process 900 includes receiving, from the network node, a second uplink grant that indicates a second amount of resources configured for a second uplink transmission, where the second amount of resources satisfies a data size of a remaining portion of the MAC-CE, and transmitting, to the network node, the second uplink transmission that includes the remaining portion of the MAC-CE based at least in part on the second amount of resources satisfying the data size of a remaining portion of the MAC-CE.

In a second aspect, alone or in combination with the first aspect, the first uplink transmission includes a segmentation header that indicates that the initial portion of the MAC-CE is a segment of the MAC-CE.

In a third aspect, alone or in combination with one or more of the first and second aspects, the initial portion of the MAC-CE includes an indication of segmentation indicating that one or more remaining portions of the MAC-CE will be transmitted in one or more subsequent uplink transmissions.

In a fourth aspect, alone or in combination with one or more of the first through third aspects, the indication of segmentation comprises a bit in a MAC header of the initial portion of the MAC-CE, where the bit indicates whether the initial portion of the MAC-CE is a segment of the MAC-CE, a full payload of the MAC-CE, or a last segment of the MAC-CE.

In a fifth aspect, alone or in combination with one or more of the first through fourth aspects, the indication of segmentation comprises a trailer byte at an end of the initial portion of the MAC-CE.

In a sixth aspect, alone or in combination with one or more of the first through fifth aspects, process 900 includes receiving, from the network node, configuration information that enables a segmentation of MAC-CEs across multiple uplink transmissions, where the first uplink transmission including the initial portion of the MAC-CE is based at least in part on the configuration information.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, at a network node or an apparatus of a network node. Example process 1000 is an example where the apparatus or the network node (e.g., network node 110) performs operations associated with transmission of medium access control information according to uplink grant sizes.

As shown in FIG. 10, in some aspects, process 1000 may include transmitting, to a UE, configuration information that configures an LCG for reporting one or more pending MAC-CEs (block 1010). For example, the network node (e.g., using transmission component 1304 or communication manager 1306, depicted in FIG. 13) may transmit, to a UE, configuration information that configures an LCG for reporting one or more pending MAC-CEs, as described above.

As further shown in FIG. 10, in some aspects, process 1000 may include transmitting, to the UE, an uplink grant that indicates a first amount of resources configured for an uplink transmission (block 1020). For example, the network node (e.g., using transmission component 1304 or communication manager 1306, depicted in FIG. 13) may transmit, to the UE, an uplink grant that indicates a first amount of resources configured for an uplink transmission, as described above.

As further shown in FIG. 10, in some aspects, process 1000 may include receiving, from the UE, the uplink transmission, where the uplink transmission includes information corresponding to the LCG, and the information is based at least in part on a second amount of resources of the uplink transmission allocated for the LCG (block 1030). For example, the network node (e.g., using reception component 1302 or communication manager 1306, depicted in FIG. 13) may receive, from the UE, the uplink transmission, where the uplink transmission includes information corresponding to the LCG, and the information is based at least in part on a second amount of resources of the uplink transmission allocated for the LCG, as described above.

Process 1000 may include additional aspects, such as any single aspect or any combination of aspects described below or in connection with one or more other processes described elsewhere herein.

In a first aspect, the configuration information indicates multiple LCGs for reporting the one or more pending MAC-CEs, where the LCG is a first LCG of the multiple LCGs that includes one or more first MAC-CEs and a second LCG of the multiple LCGs includes one or more second MAC-CEs.

In a second aspect, alone or in combination with the first aspect, the information included in the uplink transmission comprises a MAC-CE buffering at the LCG based at least in part on the second amount of resources satisfying a size of the MAC-CE.

In a third aspect, alone or in combination with one or more of the first and second aspects, the information included in the uplink transmission comprises a BSR that indicates pending MAC-CE data that is buffered at the LCG based at least in part on the second amount of resources not satisfying a size of the pending MAC-CE data.

In a fourth aspect, alone or in combination with one or more of the first through third aspects, the BSR is a full-size BSR based at least in part on the second amount of resources satisfying a size of the full-size BSR.

In a fifth aspect, alone or in combination with one or more of the first through fourth aspects, the BSR is a truncated BSR based at least in part on the second amount of resources satisfying a size of the truncated BSR and not satisfying a size of a full-size BSR.

In a sixth aspect, alone or in combination with one or more of the first through fifth aspects, the information included in the uplink transmission comprises a scheduling request based at least in part on the second amount of resources not satisfying a size of pending MAC-CE data that is buffered at the LCG and not satisfying a size of a BSR to indicate the pending MAC-CE data.

In a seventh aspect, alone or in combination with one or more of the first through sixth aspects, the configuration information indicates one or more scheduling request configurations respectively assigned to the one or more pending MAC-CEs at the LCG.

In an eighth aspect, alone or in combination with one or more of the first through seventh aspects, the information included in the uplink transmission comprises a padding BSR that indicates pending MAC-CE data that is buffered at the LCG based at least in part on the first amount of resources configured for the uplink transmission.

In a ninth aspect, alone or in combination with one or more of the first through eighth aspects, the information included in the uplink transmission comprises a delay status report that indicates pending MAC-CE data that is buffered at the LCG and a time at which the pending MAC-CE data expires.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram illustrating an example process 1100 performed, for example, at a network node or an apparatus of a network node. Example process 1100 is an example where the apparatus or the network node (e.g., network node 110) performs operations associated with transmission of medium access control information according to uplink grant sizes.

As shown in FIG. 11, in some aspects, process 1100 may include transmitting, to a UE, a first uplink grant that indicates a first amount of resources configured for a first uplink transmission, where the first amount of resources does not satisfy a data size for a MAC-CE (block 1110). For example, the network node (e.g., using transmission component 1304 or communication manager 1306, depicted in FIG. 13) may transmit, to a UE, a first uplink grant that indicates a first amount of resources configured for a first uplink transmission, where the first amount of resources does not satisfy a data size for a MAC-CE, as described above.

As further shown in FIG. 11, in some aspects, process 1100 may include receiving, from the UE, the first uplink transmission that includes a first portion of the MAC-CE, where the first amount of resources satisfies a data size of an initial portion of the MAC-CE (block 1120). For example, the network node (e.g., using reception component 1302 or communication manager 1306, depicted in FIG. 13) may receive, from the UE, the first uplink transmission that includes a first portion of the MAC-CE, where the first amount of resources satisfies a data size of an initial portion of the MAC-CE, as described above.

Process 1100 may include additional aspects, such as any single aspect or any combination of aspects described below or in connection with one or more other processes described elsewhere herein.

In a first aspect, process 1100 includes transmitting, to the UE, a second uplink grant that indicates a second amount of resources configured for a second uplink transmission, where the second amount of resources satisfies a data size of a remaining portion of the MAC-CE, and receiving, from the UE, the second uplink transmission that includes the remaining portion of the MAC-CE based at least in part on the second amount of resources satisfying the data size of a remaining portion of the MAC-CE.

In a second aspect, alone or in combination with the first aspect, the first uplink transmission includes a segmentation header that indicates that the initial portion of the MAC-CE is a segment of the MAC-CE.

In a third aspect, alone or in combination with one or more of the first and second aspects, the initial portion of the MAC-CE includes an indication of segmentation indicating that one or more remaining portions of the MAC-CE will be transmitted in one or more subsequent uplink transmissions.

In a fourth aspect, alone or in combination with one or more of the first through third aspects, the indication of segmentation comprises a bit in a MAC header of the initial portion of the MAC-CE, where the bit indicates whether the initial portion of the MAC-CE is a segment of the MAC-CE, a full payload of the MAC-CE, or a last segment of the MAC-CE.

In a fifth aspect, alone or in combination with one or more of the first through fourth aspects, the indication of segmentation comprises a trailer byte at an end of the initial portion of the MAC-CE.

In a sixth aspect, alone or in combination with one or more of the first through fifth aspects, process 1100 includes transmitting, to the UE, configuration information that enables a segmentation of MAC-CEs across multiple uplink transmissions, where the first uplink transmission including the initial portion of the MAC-CE is based at least in part on the configuration information.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram of an example apparatus 1200 for wireless communication. The apparatus 1200 may be a UE, or a UE may include the apparatus 1200. In some aspects, the apparatus 1200 includes a reception component 1202, a transmission component 1204, or a communication manager 1206, which may be in communication with one another (for example, via one or more buses or one or more other components). In some aspects, the communication manager 1206 is the communication manager 150 described in connection with FIG. 1. As shown, the apparatus 1200 may communicate with another apparatus 1208, such as a UE or a network node (such as a CU, a DU, an RU, or a base station), using the reception component 1202 and the transmission component 1204. The communication manager 1206 may be included in, or implemented via, a processing system (for example, the processing system 140 described in connection with FIG. 1) of the UE.

In some aspects, the apparatus 1200 may be configured to perform one or more operations described herein in connection with FIGS. 2 through 7. Additionally, or alternatively, the apparatus 1200 may be configured to perform one or more processes described herein, such as process 800 of FIG. 8, process 900 of FIG. 9, or a combination thereof. In some aspects, the apparatus 1200 or one or more components shown in FIG. 12 may include one or more components of the UE described in connection with FIG. 1. Additionally, or alternatively, one or more components shown in FIG. 12 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1202 may receive communications, such as reference signals, control information, data communications, or a combination thereof, from the apparatus 1208. The reception component 1202 may provide received communications to one or more other components of the apparatus 1200. In some aspects, the reception component 1202 may perform signal processing on the received communications, and may provide the processed signals to the one or more other components of the apparatus 1200. In some aspects, the reception component 1202 may include one or more components of the UE described above in connection with FIG. 1, such as a radio, one or more RF chains, one or more transceivers, or one or more modems, each of which may in turn be coupled with one or more antennas of the UE.

The transmission component 1204 may transmit communications, such as reference signals, control information, data communications, or a combination thereof, to the apparatus 1208. In some aspects, one or more other components of the apparatus 1200 may generate communications and may provide the generated communications to the transmission component 1204 for transmission to the apparatus 1208. In some aspects, the transmission component 1204 may perform signal processing on the generated communications, and may transmit the processed signals to the apparatus 1208. In some aspects, the transmission component 1204 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 1204 may be co-located with the reception component 1202.

The communication manager 1206 may support operations of the reception component 1202 or the transmission component 1204. For example, the communication manager 1206 may receive information associated with configuring reception of communications by the reception component 1202 or transmission of communications by the transmission component 1204. Additionally, or alternatively, the communication manager 1206 may generate or provide control information to the reception component 1202 or the transmission component 1204 to control reception or transmission of communications.

The reception component 1202 may receive, from a network node, configuration information that configures an LCG for reporting one or more pending MAC-CEs. The reception component 1202 may receive, from the network node, an uplink grant that indicates a first amount of resources configured for an uplink transmission. The transmission component 1204 may transmit, to the network node, the uplink transmission, wherein the uplink transmission includes information corresponding to the LCG, and wherein the information is based at least in part on a second amount of resources of the uplink transmission allocated for the LCG.

The communication manager 1206 may perform a data volume calculation for MAC-CE data buffered at the LCG, wherein the data volume calculation is based at least in part on the one or more pending MAC-CEs or a subset of the one or more pending MAC-CEs that is indicated in the configuration information.

The reception component 1202 may receive, from a network node, a first uplink grant that indicates a first amount of resources configured for a first uplink transmission, wherein the first amount of resources does not satisfy a data size for a MAC-CE. The transmission component 1204 may transmit, to the network node, the first uplink transmission that includes a first portion of the MAC-CE, wherein the first amount of resources satisfies a data size of an initial portion of the MAC-CE.

The reception component 1202 may receive, from the network node, a second uplink grant that indicates a second amount of resources configured for a second uplink transmission, wherein the second amount of resources satisfies a data size of a remaining portion of the MAC-CE.

The transmission component 1204 may transmit, to the network node, the second uplink transmission that includes the remaining portion of the MAC-CE based at least in part on the second amount of resources satisfying the data size of a remaining portion of the MAC-CE.

The reception component 1202 may receive, from the network node, configuration information that enables a segmentation of MAC-CEs across multiple uplink transmissions, wherein the first uplink transmission including the initial portion of the MAC-CE is based at least in part on the configuration information.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

FIG. 13 is a diagram of an example apparatus 1300 for wireless communication. The apparatus 1300 may be a network node, or a network node may include the apparatus 1300. In some aspects, the apparatus 1300 includes a reception component 1302, a transmission component 1304, or a communication manager 1306, which may be in communication with one another (for example, via one or more buses or one or more other components). In some aspects, the communication manager 1306 is the communication manager 155 described in connection with FIG. 1. As shown, the apparatus 1300 may communicate with another apparatus 1308, such as a UE or a network node (such as a CU, a DU, an RU, or a base station), using the reception component 1302 and the transmission component 1304. The communication manager 1306 may be included in, or implemented via, a processing system (for example, the processing system 145 described in connection with FIG. 1) of the network node.

In some aspects, the apparatus 1300 may be configured to perform one or more operations described herein in connection with FIGS. 2 through 7. Additionally, or alternatively, the apparatus 1300 may be configured to perform one or more processes described herein, such as process 1000 of FIG. 10, process 1100 of FIG. 11, or a combination thereof. In some aspects, the apparatus 1300 or one or more components shown in FIG. 13 may include one or more components of the network node described in connection with FIG. 1. Additionally, or alternatively, one or more components shown in FIG. 13 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1302 may receive communications, such as reference signals, control information, data communications, or a combination thereof, from the apparatus 1308. The reception component 1302 may provide received communications to one or more other components of the apparatus 1300. In some aspects, the reception component 1302 may perform signal processing on the received communications, and may provide the processed signals to the one or more other components of the apparatus 1300. In some aspects, the reception component 1302 may include one or more components of the network node described above in connection with FIG. 1, such as a radio, one or more RF chains, one or more transceivers, or one or more modems, each of which may in turn be coupled with one or more antennas of the network node. In some aspects, the reception component 1302 or the transmission component 1304 may include or may be included in a network interface. The network interface may be configured to obtain or output signals for the apparatus 1300 via one or more communications links, such as a backhaul link, a midhaul link, or a fronthaul link.

The transmission component 1304 may transmit communications, such as reference signals, control information, data communications, or a combination thereof, to the apparatus 1308. In some aspects, one or more other components of the apparatus 1300 may generate communications and may provide the generated communications to the transmission component 1304 for transmission to the apparatus 1308. In some aspects, the transmission component 1304 may perform signal processing on the generated communications, and may transmit the processed signals to the apparatus 1308. In some aspects, the transmission component 1304 may include one or more components of the network node described above in connection with FIG. 1, such as a radio, one or more RF chains, one or more transceivers, or one or more modems, each of which may in turn be coupled with one or more antennas of the network node described in connection with FIG. 1. In some aspects, the transmission component 1304 may be co-located with the reception component 1302.

The communication manager 1306 may support operations of the reception component 1302 or the transmission component 1304. For example, the communication manager 1306 may receive information associated with configuring reception of communications by the reception component 1302 or transmission of communications by the transmission component 1304. Additionally, or alternatively, the communication manager 1306 may generate or provide control information to the reception component 1302 or the transmission component 1304 to control reception or transmission of communications.

The transmission component 1304 may transmit, to a UE, configuration information that configures an LCG for reporting one or more pending MAC-CEs. The transmission component 1304 may transmit, to the UE, an uplink grant that indicates a first amount of resources configured for an uplink transmission. The reception component 1302 may receive, from the UE, the uplink transmission, wherein the uplink transmission includes information corresponding to the LCG, and wherein the information is based at least in part on a second amount of resources of the uplink transmission allocated for the LCG.

The transmission component 1304 may transmit, to a UE, a first uplink grant that indicates a first amount of resources configured for a first uplink transmission, wherein the first amount of resources does not satisfy a data size for a MAC-CE. The reception component 1302 may receive, from the UE, the first uplink transmission that includes a first portion of the MAC-CE, wherein the first amount of resources satisfies a data size of an initial portion of the MAC-CE.

The transmission component 1304 may transmit, to the UE, a second uplink grant that indicates a second amount of resources configured for a second uplink transmission, wherein the second amount of resources satisfies a data size of a remaining portion of the MAC-CE.

The reception component 1302 may receive, from the UE, the second uplink transmission that includes the remaining portion of the MAC-CE based at least in part on the second amount of resources satisfying the data size of a remaining portion of the MAC-CE.

The transmission component 1304 may transmit, to the UE, configuration information that enables a segmentation of MAC-CEs across multiple uplink transmissions, wherein the first uplink transmission including the initial portion of the MAC-CE is based at least in part on the configuration information.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

The following provides an overview of some Aspects of the present disclosure:
Aspect 1: A method of wireless communication performed by a user equipment (UE), comprising: receiving, from a network node, configuration information that configures a logical channel group (LCG) for reporting one or more pending medium access control (MAC) control elements (MAC-CEs); receiving, from the network node, an uplink grant that indicates a first amount of resources configured for an uplink transmission; and transmitting, to the network node, the uplink transmission, wherein the uplink transmission includes information corresponding to the LCG, and wherein the information is based at least in part on a second amount of resources of the uplink transmission allocated for the LCG.
Aspect 2: The method of Aspect 1, further comprising: performing a data volume calculation for MAC-CE data buffered at the LCG, wherein the data volume calculation is based at least in part on the one or more pending MAC-CEs or a subset of the one or more pending MAC-CEs that is indicated in the configuration information.
Aspect 3: The method of any of Aspects 1-2, wherein the configuration information indicates multiple LCGs for reporting the one or more pending MAC-CEs, wherein the LCG is a first LCG of the multiple LCGs that includes one or more first MAC-CEs and a second LCG of the multiple LCGs includes one or more second MAC-CEs.
Aspect 4: The method of any of Aspects 1-3, wherein the information included in the uplink transmission comprises a MAC-CE buffering at the LCG based at least in part on the second amount of resources satisfying a size of the MAC-CE.
Aspect 5: The method of any of Aspects 1-4, wherein the information included in the uplink transmission comprises a buffer status report that indicates pending MAC-CE data that is buffered at the LCG based at least in part on the second amount of resources not satisfying a size of the pending MAC-CE data.
Aspect 6: The method of Aspect 5, wherein the buffer status report is a full-size buffer status report based at least in part on the second amount of resources satisfying a size of the full-size buffer status report.
Aspect 7: The method of Aspect 5, wherein the buffer status report is a truncated buffer status report based at least in part on the second amount of resources satisfying a size of the truncated buffer status report and not satisfying a size of a full-size buffer status report.
Aspect 8: The method of any of Aspects 1-7, wherein the information included in the uplink transmission comprises a scheduling request based at least in part on the second amount of resources not satisfying a size of pending MAC-CE data that is buffered at the LCG and not satisfying a size of a buffer status report to indicate the pending MAC-CE data.
Aspect 9: The method of any of Aspects 1-8, wherein the configuration information indicates one or more scheduling request configurations respectively assigned to the one or more pending MAC-CEs at the LCG.
Aspect 10: The method of any of Aspects 1-9, wherein the information included in the uplink transmission comprises a padding buffer status report that indicates pending MAC-CE data that is buffered at the LCG based at least in part on the first amount of resources configured for the uplink transmission.
Aspect 11: The method of any of Aspects 1-10, wherein the information included in the uplink transmission comprises a delay status report that indicates pending MAC-CE data that is buffered at the LCG and a time at which the pending MAC-CE data expires.
Aspect 12: A method of wireless communication performed by a user equipment (UE), comprising: receiving, from a network node, a first uplink grant that indicates a first amount of resources configured for a first uplink transmission, wherein the first amount of resources does not satisfy a data size for a medium access control (MAC) control element (MAC-CE); and transmitting, to the network node, the first uplink transmission that includes a first portion of the MAC-CE, wherein the first amount of resources satisfies a data size of an initial portion of the MAC-CE.
Aspect 13: The method of Aspect 12, further comprising: receiving, from the network node, a second uplink grant that indicates a second amount of resources configured for a second uplink transmission, wherein the second amount of resources satisfies a data size of a remaining portion of the MAC-CE; and transmitting, to the network node, the second uplink transmission that includes the remaining portion of the MAC-CE based at least in part on the second amount of resources satisfying the data size of a remaining portion of the MAC-CE.
Aspect 14: The method of any of Aspects 12-13, wherein the first uplink transmission includes a segmentation header that indicates that the initial portion of the MAC-CE is a segment of the MAC-CE.
Aspect 15: The method of any of Aspects 12-14, wherein the initial portion of the MAC-CE includes an indication of segmentation indicating that one or more remaining portions of the MAC-CE will be transmitted in one or more subsequent uplink transmissions.
Aspect 16: The method of Aspect 15, wherein the indication of segmentation comprises a bit in a MAC header of the initial portion of the MAC-CE, wherein the bit indicates whether the initial portion of the MAC-CE is a segment of the MAC-CE, a full payload of the MAC-CE, or a last segment of the MAC-CE.
Aspect 17: The method of Aspect 15, wherein the indication of segmentation comprises a trailer byte at an end of the initial portion of the MAC-CE.
Aspect 18: The method of any of Aspects 12-17, further comprising: receiving, from the network node, configuration information that enables a segmentation of MAC-CEs across multiple uplink transmissions, wherein the first uplink transmission including the initial portion of the MAC-CE is based at least in part on the configuration information.
Aspect 19: A method of wireless communication performed by a network node, comprising: transmitting, to a user equipment (UE), configuration information that configures a logical channel group (LCG) for reporting one or more pending medium access control (MAC) control elements (MAC-CEs); transmitting, to the UE, an uplink grant that indicates a first amount of resources configured for an uplink transmission; and receiving, from the UE, the uplink transmission, wherein the uplink transmission includes information corresponding to the LCG, and wherein the information is based at least in part on a second amount of resources of the uplink transmission allocated for the LCG.
Aspect 20: The method of Aspect 19, wherein the configuration information indicates multiple LCGs for reporting the one or more pending MAC-CEs, wherein the LCG is a first LCG of the multiple LCGs that includes one or more first MAC-CEs and a second LCG of the multiple LCGs includes one or more second MAC-CEs.
Aspect 21: The method of any of Aspects 19-20, wherein the information included in the uplink transmission comprises a MAC-CE buffering at the LCG based at least in part on the second amount of resources satisfying a size of the MAC-CE.
Aspect 22: The method of any of Aspects 19-21, wherein the information included in the uplink transmission comprises a buffer status report that indicates pending MAC-CE data that is buffered at the LCG based at least in part on the second amount of resources not satisfying a size of the pending MAC-CE data.
Aspect 23: The method of Aspect 22, wherein the buffer status report is a full-size buffer status report based at least in part on the second amount of resources satisfying a size of the full-size buffer status report.
Aspect 24: The method of Aspect 22, wherein the buffer status report is a truncated buffer status report based at least in part on the second amount of resources satisfying a size of the truncated buffer status report and not satisfying a size of a full-size buffer status report.
Aspect 25: The method of any of Aspects 19-24, wherein the information included in the uplink transmission comprises a scheduling request based at least in part on the second amount of resources not satisfying a size of pending MAC-CE data that is buffered at the LCG and not satisfying a size of a buffer status report to indicate the pending MAC-CE data.
Aspect 26: The method of any of Aspects 19-25, wherein the configuration information indicates one or more scheduling request configurations respectively assigned to the one or more pending MAC-CEs at the LCG.
Aspect 27: The method of any of Aspects 19-26, wherein the information included in the uplink transmission comprises a padding buffer status report that indicates pending MAC-CE data that is buffered at the LCG based at least in part on the first amount of resources configured for the uplink transmission.
Aspect 28: The method of any of Aspects 19-27, wherein the information included in the uplink transmission comprises a delay status report that indicates pending MAC-CE data that is buffered at the LCG and a time at which the pending MAC-CE data expires.
Aspect 29: A method of wireless communication performed by a network node, comprising: transmitting, to a user equipment (UE), a first uplink grant that indicates a first amount of resources configured for a first uplink transmission, wherein the first amount of resources does not satisfy a data size for a medium access control (MAC) control element (MAC-CE); and receiving, from the UE, the first uplink transmission that includes a first portion of the MAC-CE, wherein the first amount of resources satisfies a data size of an initial portion of the MAC-CE.
Aspect 30: The method of Aspect 29, further comprising: transmitting, to the UE, a second uplink grant that indicates a second amount of resources configured for a second uplink transmission, wherein the second amount of resources satisfies a data size of a remaining portion of the MAC-CE; and receiving, from the UE, the second uplink transmission that includes the remaining portion of the MAC-CE based at least in part on the second amount of resources satisfying the data size of a remaining portion of the MAC-CE.
Aspect 31: The method of any of Aspects 29-30, wherein the first uplink transmission includes a segmentation header that indicates that the initial portion of the MAC-CE is a segment of the MAC-CE.
Aspect 32: The method of any of Aspects 29-31, wherein the initial portion of the MAC-CE includes an indication of segmentation indicating that one or more remaining portions of the MAC-CE will be transmitted in one or more subsequent uplink transmissions.
Aspect 33: The method of Aspect 32, wherein the indication of segmentation comprises a bit in a MAC header of the initial portion of the MAC-CE, wherein the bit indicates whether the initial portion of the MAC-CE is a segment of the MAC-CE, a full payload of the MAC-CE, or a last segment of the MAC-CE.
Aspect 34: The method of Aspect 32, wherein the indication of segmentation comprises a trailer byte at an end of the initial portion of the MAC-CE.
Aspect 35: The method of any of Aspects 29-34, further comprising: transmitting, to the UE, configuration information that enables a segmentation of MAC-CEs across multiple uplink transmissions, wherein the first uplink transmission including the initial portion of the MAC-CE is based at least in part on the configuration information.
Aspect 36: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-35.
Aspect 37: An apparatus for wireless communication at a device, the apparatus comprising one or more memories and one or more processors coupled to the one or more memories, the one or more processors configured to cause the device to perform the method of one or more of Aspects 1-35.
Aspect 38: An apparatus for wireless communication, the apparatus comprising at least one means for performing the method of one or more of Aspects 1-35.
Aspect 39: A non-transitory computer-readable medium storing code for wireless communication, the code comprising instructions executable by one or more processors to perform the method of one or more of Aspects 1-35.
Aspect 40: A non-transitory computer-readable medium storing a set of instructions for wireless communication, the set of instructions comprising one or more instructions that, when executed by one or more processors of a device, cause the device to perform the method of one or more of Aspects 1-35.
Aspect 41: A device for wireless communication, the device comprising a processing system that includes one or more processors and one or more memories coupled with the one or more processors, the processing system configured to cause the device to perform the method of one or more of Aspects 1-35.
Aspect 42: An apparatus for wireless communication at a device, the apparatus comprising one or more memories and one or more processors coupled to the one or more memories, the one or more processors individually or collectively configured to cause the device to perform the method of one or more of Aspects 1-35.
Aspect 43: A device comprising a processing system that includes one or more processors and one or more code-storing memories coupled with the one or more processors, the processing system configured to cause the device to perform the method of one or more of Aspects 1-35.
Aspect 44: A device comprising a processing system that includes processor circuitry and code-storing memory circuitry, the processing system configured to cause the device to perform the method of one or more of Aspects 1-35.

It will be apparent that systems or methods described herein may be implemented in different forms of hardware or a combination of hardware and software. A component being configured to perform a function means that the component has a capability to perform the function, and does not require the function to be actually performed by the component, unless noted otherwise.

As used herein, the term “determine” or “determining” can encompass one or more of a wide variety of actions. For example, “determining” can include one or more of calculating, computing, processing, deriving, detecting, estimating, investigating, looking up, inferring, ascertaining, measuring, resolving, selecting, choosing, obtaining, identifying, interpreting, demodulating, decoding, reading, establishing, forming or generating, among other examples. In some such examples, determining can involve a processor performing some type of calculating, computing, deriving, estimating, inferring, ascertaining, resolving, predicting or other processing to obtain one or more numerical values, sets, elements or other information or results. In some other such examples, determining can involve a processor identifying, looking up, investigating or otherwise obtaining some type of value, set, element or other information or result from a table, a data structure, a database or other memory device or location. In some other such examples, determining can involve a processor identifying, interpreting, demodulating, decoding, detecting, reading or otherwise obtaining some type of value, set, element or other information or result signaled in, for example, a received wireless packet. In some other such examples, determining can involve a processor selecting or choosing one or more values, sets, elements or other information or results from a larger set of values, sets elements or other information or results. In some other such examples, determining can involve a processor performing a measurement, such as on a received signal.

As used herein, the articles “a” and “an” are intended to refer to one or more items and may be used interchangeably with “one or more” or “at least one.” As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Additionally, as used herein, a “set” can refer to one or more items, and a “subset” can refer to a whole set or less than the whole set, but not an empty set. “Set,” “group,” and similar terms are intended to include one or more items and may be used interchangeably with “one or more.” Furthermore, as used herein, the term “or” is intended to be interpreted in the inclusive sense (such as when referring to a series) and may be used interchangeably with “and/or,” unless otherwise explicitly indicated (for example, if used in conjunction with “either” or “only one of”). For example, “A or B” may include A only, B only, or a combination of A and B. Also, as used herein, the terms “has,” “have,” “having,” “comprise,” “comprising,” “include” and “including,” and derivatives thereof or similar terms are intended to be open-ended terms that do not limit an element that they modify (for example, an element “having” A also may have B).

As used herein, the phrase “associated with” is intended to be interpreted in the inclusive sense, unless otherwise explicitly indicated. For example, the phrase “associated with” is not to be construed as a reference to a closed set of conditions, factors, criteria, elements, components, or actions, among other examples. Specifically, unless a phrase refers to “associated with only ‘a,’” or the equivalent in context, whatever it is that is “associated with ‘a,’” may be associated with “a” alone or associated with a combination of “a” and one or more other conditions, factors, criteria, elements, components, or actions, among other examples.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A user equipment (UE) for wireless communication, comprising:
one or more memories; and
one or more processors, coupled to the one or more memories, configured to cause the UE to:
receive, from a network node, configuration information that configures a logical channel group (LCG) for reporting one or more pending medium access control (MAC) control elements (MAC-CEs);
receive, from the network node, an uplink grant that indicates a first amount of resources configured for an uplink transmission; and
transmit, to the network node, the uplink transmission, wherein the uplink transmission includes information corresponding to the LCG, and wherein the information is based at least in part on a second amount of resources of the uplink transmission allocated for the LCG.

2. The UE of claim 1, wherein the one or more processors are further configured to cause the UE to:
perform a data volume calculation for MAC-CE data buffered at the LCG, wherein the data volume calculation is based at least in part on the one or more pending MAC-CEs or a subset of the one or more pending MAC-CEs that is indicated in the configuration information.

3. The UE of claim 1, wherein the configuration information indicates multiple LCGs for reporting the one or more pending MAC-CEs, wherein the LCG is a first LCG of the multiple LCGs that includes one or more first MAC-CEs and a second LCG of the multiple LCGs includes one or more second MAC-CEs.

4. The UE of claim 1, wherein the information included in the uplink transmission comprises a MAC-CE buffering at the LCG based at least in part on the second amount of resources satisfying a size of the MAC-CE.

5. The UE of claim 1, wherein the information included in the uplink transmission comprises a buffer status report that indicates pending MAC-CE data that is buffered at the LCG based at least in part on the second amount of resources not satisfying a size of the pending MAC-CE data.

6. The UE of claim 5, wherein the buffer status report is a full-size buffer status report based at least in part on the second amount of resources satisfying a size of the full-size buffer status report.

7. The UE of claim 5, wherein the buffer status report is a truncated buffer status report based at least in part on the second amount of resources satisfying a size of the truncated buffer status report and not satisfying a size of a full-size buffer status report.

8. The UE of claim 1, wherein the information included in the uplink transmission comprises a scheduling request based at least in part on the second amount of resources not satisfying a size of pending MAC-CE data that is buffered at the LCG and not satisfying a size of a buffer status report to indicate the pending MAC-CE data.

9. The UE of claim 1, wherein the configuration information indicates one or more scheduling request configurations respectively assigned to the one or more pending MAC-CEs at the LCG.

10. The UE of claim 1, wherein the information included in the uplink transmission comprises a padding buffer status report that indicates pending MAC-CE data that is buffered at the LCG based at least in part on the first amount of resources configured for the uplink transmission.

11. The UE of claim 1, wherein the information included in the uplink transmission comprises a delay status report that indicates pending MAC-CE data that is buffered at the LCG and a time at which the pending MAC-CE data expires.

12. A user equipment (UE) for wireless communication, comprising:
one or more memories; and
one or more processors, coupled to the one or more memories, configured to cause the UE to:
receive, from a network node, a first uplink grant that indicates a first amount of resources configured for a first uplink transmission, wherein the first amount of resources does not satisfy a data size for a medium access control (MAC) control element (MAC-CE); and
transmit, to the network node, the first uplink transmission that includes a first portion of the MAC-CE, wherein the first amount of resources satisfies a data size of an initial portion of the MAC-CE.

13. The UE of claim 12, wherein the one or more processors are further configured to cause the UE to:
receive, from the network node, a second uplink grant that indicates a second amount of resources configured for a second uplink transmission, wherein the second amount of resources satisfies a data size of a remaining portion of the MAC-CE; and
transmit, to the network node, the second uplink transmission that includes a remaining portion of the MAC-CE based at least in part on the second amount of resources satisfying a data size of the remaining portion of the MAC-CE.

14. The UE of claim 12, wherein the first uplink transmission includes a segmentation header that indicates that the initial portion of the MAC-CE is a segment of the MAC-CE.

15. The UE of claim 12, wherein the initial portion of the MAC-CE includes an indication of segmentation indicating that one or more remaining portions of the MAC-CE will be transmitted in one or more subsequent uplink transmissions.

16. The UE of claim 15, wherein the indication of segmentation comprises a bit in a MAC header of the initial portion of the MAC-CE, wherein the bit indicates whether the initial portion of the MAC-CE is a segment of the MAC-CE, a full payload of the MAC-CE, or a last segment of the MAC-CE.

17. The UE of claim 15, wherein the indication of segmentation comprises a trailer byte at an end of the initial portion of the MAC-CE.

18. The UE of claim 12, wherein the one or more processors are further configured to cause the UE to:
receive, from the network node, configuration information that enables a segmentation of MAC-CEs across multiple uplink transmissions, wherein the first uplink transmission including the initial portion of the MAC-CE is based at least in part on the configuration information.

19. A method of wireless communication performed by a user equipment (UE), comprising:
receiving, from a network node, configuration information that configures a logical channel group (LCG) for reporting one or more pending medium access control (MAC) control elements (MAC-CEs);
receiving, from the network node, an uplink grant that indicates a first amount of resources configured for an uplink transmission; and
transmitting, to the network node, the uplink transmission, wherein the uplink transmission includes information corresponding to the LCG, and wherein the information is based at least in part on a second amount of resources of the uplink transmission allocated for the LCG.

20. The method of claim 19, further comprising:
performing a data volume calculation for MAC-CE data buffered at the LCG, wherein the data volume calculation is based at least in part on the one or more pending MAC-CEs or a subset of the one or more pending MAC-CEs that is indicated in the configuration information.
